(19) United States
(12) Patent Application Publication
(10) Pub. No.: US 2026/0163763 A1
(43) Pub. Date: Jun. 11, 2026

(54) METHOD AND APPARATUS FOR COMMUNICATIONS

(71) Applicant: Huawei Technologies Co., Ltd., Shenzhen (CN)

(72) Inventors: Xiaoyan Bi, Shanghai (CN); Yiqun Ge, Ottawa (CA); Wuxian Shi, Ottawa (CA); Jianglei Ma, Ottawa (CA)

(21) Appl. No.: 19/412,191

(22) Filed: Dec. 8, 2025

Related U.S. Application Data
(63) Continuation of application No. PCT/CN2023/117867, filed on Sep. 8, 2023.
(60) Provisional application No. 63/507,230, filed on Jun. 9, 2023.

(51) Int. Cl. H04L 25/02

(52) U.S. Cl. CPC H04L 25/0204; H04L 25/0224; H04L 25/0254

(57) ABSTRACT

Embodiments of the present application provide a method and an apparatus for communications. A receiving apparatus obtains common information and information of K reference channel(s). The common information is used for determining information of a downlink (DL) channel between a transmitting apparatus and the receiving apparatus, and the K reference channel(s) is related to an environment parameter set. The receiving apparatus transmits feedback information based on the common information and the information of the K reference channel(s), and the feedback information includes the information of the DL channel.

### CROSS-REFERENCE TO RELATED APPLICATIONS

This application is a continuation of International Application No. PCT/CN2023/117867, filed on Sep. 8, 2023, which claims priority to U.S. Provisional Patent Application No. 63/507,230, filed on Jun. 9, 2023. The disclosures of the aforementioned applications are hereby incorporated by reference in their entireties.

### TECHNICAL FIELD

Embodiments of the present invention relate to the field of wireless technologies, and more specifically, to a method and an apparatus for communications.

### BACKGROUND

For a wireless system, (multi-user-multiple-in-multiple-out) MU-MIMO is usually used in downlink (DL), where a base station (BS) is a transmitting apparatus and multiple user equipments (UEs) are corresponding receiving apparatus. MIMO channels of multiple UEs are paired by a common precoder to multiplex on the frequency and time resources. For higher throughput and system efficiency, modern MU-MIMO system deploys lots of antenna ports across a wider band. For example, in a terabit-MIMO (T-MIMO) system, it is expected that BS has 3072 antenna ports and UE has 64 antenna ports over 400 MHz bandwidth. MIMO channel becomes a three-dimensional tensor.

In a massive MIMO system, for example, the T-MIMO system, how to estimate and report information of a downlink (DL) channel with a reasonable overhead is a challenging problem that needs to be solved urgently.

### SUMMARY

Embodiments of the present application provide a method and an apparatus for communications, which make a receiving apparatus estimate and report information of a DL channel with a reasonable overhead in a MIMO system.

According to a first aspect, there is provided a method for communications, and the method may be performed by a receiving apparatus or a chip installed in the receiving apparatus. The method includes: obtaining common information and information of K reference channel(s), where the K reference channel(s) is related to an environment parameter set, the common information is used for determining information of a downlink (DL) channel, and K is a positive integer; and transmitting feedback information based on the common information and the information of the K reference channel(s), where the feedback information includes the information of the DL channel.

In embodiments of the present application, a new concept of “reference channel” is proposed. A receiving apparatus obtains common information and information of K reference channel(s). The common information is used for determining information of a DL channel between a transmitting apparatus and the receiving apparatus, and the K reference channel(s) is related to an environment parameter set. The receiving apparatus transmits feedback information based on the common information and the information of the K reference channel(s), and the feedback information includes the information of the DL channel. In this way, channel estimation of a DL channel may not be an absolute estimation but a relative estimation, and the receiving apparatus may report relative estimation information instead of absolute estimation information of the DL channel. The relative estimation and feedback of the relative estimation information make the receiving apparatus estimate and report information of the DL channel with a reasonable overhead in a MIMO system.

In an implementation of the first aspect, the method further includes: transmitting the common information and the information of the K reference channel(s).

In this implementation, the receiving apparatus obtains the common information and the information of the K reference channel(s), and transmits them to the transmitting apparatus. Information of a first channel may be highly compressed information since the common information could be used to compress the channel estimation information of the first channel, and much storage and computation complexity could be saved.

In an implementation of the first aspect, obtaining the common information and the information of the K reference channel(s) includes: obtaining the common information and the information of the K reference channel(s) based on channel measurement.

In this implementation, the common information and the information of the K reference channel(s) are obtained by the receiving apparatus based on channel measurement with one or more reference signals transmitted by the transmitting apparatus.

Optionally, the reference signal for the channel measurement may be a non-uniform and super sparse pilot pattern in some embodiments of the present application. The non-uniform and super sparse pilot pattern of the present application requires several-order lower pilot density than the uniform one in the prior art. Therefore, an overhead in terms of pilots is reduced.

In an implementation of the first aspect, determining whether the first reference channel(s) needs to be updated by channel measurement includes: obtaining an estimation result of the DL channel; and determining whether the first reference channel(s) needs to be updated according to the estimation result and the information of the K reference channel(s).

In this implementation, after the first reference channel is determined, the receiving apparatus may keep tracking the first reference channel, and transmit information to confirm the first reference channel, which supports a high mobility scenario.

According to a second aspect, there is provided a method for communications, and the method may be performed by a transmitting apparatus or a chip installed in the transmitting apparatus. The method includes: receiving feedback information, where the feedback information includes information of a downlink (DL) channel, the feedback information is based on common information and information of K reference channel(s), the K reference channel(s) is related to an environment parameter set, the common information is used for determining the information of the DL channel, and K is a positive integer.

The technical effect of the second aspect can refer to that of the first aspect, and it will not be repeated herein.

In an implementation of the second aspect, the method further includes: receiving the common information and the information of the K reference channel(s).

In an implementation of the second aspect, the method further includes: transmitting a reference signal for determining whether the first reference channel(s) needs to be updated.

In an implementation of the first aspect or the second aspect, the information of the DL channel includes index(es) of first reference channel(s), and a distance between the DL channel and the first reference channel is less than or equal to a threshold.

In this implementation, the information of the DL channel may indicate one or more first reference channels, and the one or more first reference channels are representative(s) of the first channel. Since the information of the one or more first reference channels are acquired at the transmitting apparatus in advance, the receiving apparatus reports the information of the one or more first reference channels, for example, index(es) of the first reference channel(s), instead of channel estimation information of the first channel, and an overhead related to pairing and precoder matrix computation, for example, an overhead in terms of computation and storage, is significantly reduced.

In an implementation of the first aspect or the second aspect, the common information includes any one of:
a channel space basis U, or projection of a channel space basis U to a predefined matrix, and the common information is represented based on a matrix; or
a first parameter of an encoding DNN function and a second parameter of a decoding DNN function, and the common information is represented based on DNN.

The common information may be represented in various forms, and could be used to compress the channel estimation information of the first channel (i.e. DL channel) into an equivalent low-dimensional space. In this way, much storage and computation overhead could be saved.

In an implementation of the first aspect or the second aspect, the K reference channel(s) includes a second reference channel, and the information of the K reference channel(s) further includes one or more of:
a set of matrixes Q that are related to the second reference channel, where each of the matrixes Q is an orthonormal projection matrix by QR decomposition of the second reference channel; and
a matrix R that is related to the second reference channel, where the matrix R is an up-triangular square matrix by QR decomposition of the second reference channel.

In this implementation, the information of the K reference channel(s) may be the matrixes Q and R related to the K reference channel(s) respectively. A set of matrixes Q related to a second reference channel are used to replace channel estimation information of the second reference channel for pairing calculation at the transmitting apparatus, and the set of the matrixes Q and the matrix R related to the second reference channel are used to replace channel estimation information of the second reference channel for precoder matrix computation. Compared with the prior art using channel estimation information for pairing and precoder matrix computation, the solution of the present application could reduce computation complexity.

In an implementation of the first aspect or the second aspect, a reference signal for determining whether the first reference channel(s) needs to be updated includes any one of:
a reference signal derived from a channel space basis U, and the common information is represented by the channel space basis U;
a non-precoded reference channel; and
a precoded reference signal.

In this way, in a case that the reference signal is derived from the channel space basis U, the reference signal may be a non-uniform and super sparse pilot pattern. The non-uniform and super sparse pilot pattern of the present application requires several-order lower pilot density than the uniform one in the prior art. Therefore, an overhead in terms of pilots is reduced.

According to a third aspect, there is provided a communication apparatus having a function or unit to perform the method in the first aspect and any one of the implementations in the first aspect.

According to a fourth aspect, there is provided a communication apparatus having a function or unit to perform the method in the second aspect and any one of the implementations in the second aspect.

According to a fifth aspect, there is provided a chip (or a chip system). The chip includes at least one processor, the at least one processor is coupled to at least one memory. The at least one memory is configured to store one or more instructions and/or executable computer code. The at least one processor is configured to invoke the one or more instructions and/or executable computer code, so that a communication apparatus installed the chip performs the method provided in the first aspect and any possible implementation provided in the first aspect, or the communication performs the method provided in the second aspect and any possible implementation provided in the second aspect. Optionally, the chip may further include the at least one memory. Optionally, the chip may further include a communication interface, and the communication interface is configured to input and/or output information or data.

According to a sixth aspect, there is provided a communication apparatus. The communication apparatus includes one or more circuits and one or more communication interfaces. The one or more communication interfaces may include a first interface for receiving (that is, inputting) information and/or data that is to be processed by the one or more circuits and a second interface for transmitting (that is, outputting) information and/or data processed by the one or more circuit. The one or more circuits are configured to process the information and/or data that is to be processed so that the communication apparatus performs the method in the first aspect and any one of the implementations in the first aspect, or performs the method in the second aspect and any one of the implementations in the second aspect.

According to a seventh aspect, there is provided a communication system. The communication system may include the communication apparatus according to the third aspect and the communication apparatus according to the fourth aspect.

According to an eighth aspect, there is provided a computer storage medium that stores executable computer code, and the executable computer code is used to execute one or more instructions for the method according to the first aspect or any possible implementation of the first aspect, or the second aspect or any possible implementation of the second aspect.

According to a ninth aspect, there is provided a computer program product including one or more instructions, and when the computer product program runs on a computer, the computer performs the method according to the first aspect or any possible implementation of the first aspect, or the second aspect or any possible implementation of the second aspect.

### DESCRIPTION OF THE DRAWINGS

One or more embodiments are exemplarily described by corresponding accompanying drawings, and these exemplary illustrations and accompanying drawings constitute no limitation on the embodiments. Elements with the same reference numerals in the accompanying drawings are illustrated as similar elements, and the drawings are not limited to scale, in which:

FIG. 1 is a schematic diagram of an application scenario according to an embodiment of the present application.

FIG. 2 illustrates an example of a communication system.

FIG. 3 illustrates another example of an electronic device (ED) and a base station.

FIG. 4 is an example of a channel model of a MIMO system.

FIG. 5 is a schematic flow chart of a method for communications proposed by an embodiment of the present application.

FIG. 6 shows an example to vectorize a tensor-formed MIMO channel data sample according to an embodiment of the present application.

FIG. 7 shows an example of column-wisely juxtaposing column-wised vectorized channel data samples into a matrix according to an embodiment of the present application.

FIG. 8 shows an example of an equivalent low-dimensional space.

FIG. 9 shows an example of a pilot pattern matrix P.

FIG. 10 shows an example of DNN implementation approaches a channel space basis U.

FIG. 11 shows an example of a scoring function for measuring a distance between two channel data samples on an equivalent low-dimensional space.

FIG. 12 shows an example of a DNN-based scoring function for measuring a distance between two channel data samples on an equivalent low-dimensional latent space.

FIG. 13 to FIG. 17 are examples of the method according to embodiments of the present application.

FIG. 18 is a schematic block diagram of a communication apparatus according to an embodiment of the present application.

FIG. 19 is a schematic block diagram of a communication apparatus according to an embodiment of the present application.

FIG. 20 is a schematic block diagram of a communication apparatus according to an embodiment of the present application.

FIG. 21 is a schematic block diagram of a communication apparatus according to an embodiment of the present application.

FIG. 22 shows dimensionality of a TMIMO channel.

FIG. 23 shows selection of representative nodes based on graph on the “distance” among the data samples.

FIG. 24 to FIG. 28 are examples of embodiments of the present application.

FIG. 29 shows an example of a basic module structure according to an embodiment of the present application.

### DETAILED DESCRIPTION OF THE ILLUSTRATIVE EMBODIMENTS

In order to understand features and technical contents of embodiments of the present application in detail, implementations of the embodiments of the present application will be described in detail below with reference to the accompanying drawings, and the attached drawings are only for reference and illustration purposes, and are not intended to limit the embodiments of the present applications. In the following technical descriptions, for ease of explanation, numerous details are set forth to provide a thorough understanding of the disclosed embodiments.

Related technologies and concepts are introduced here firstly in order to have better understanding of technical solution proposed by the present application.

Firstly, the 5G system employs an SRS UL channel to measure UL MIMO channels between a BS (as a transmitting apparatus) and multiple UEs (as receiving apparatus). The BS would assume its measured or estimated UL MIMO channels from its SRS UL channel(s) as its DL MIMO channels between the BS and the UEs in a TDD mode. This will result in several disadvantages as follows.

The first disadvantage is due to assumption about DL/UL channel reciprocity. Although the over-the-air part of a MIMO channel can typically meet UL/DL reciprocity thanks to information theory I(X,Y)=I(Y,X),I(X,Y) is the mutual information of two random variables X and Y), the RF and IF components (analogy circuits) do not generally hold UL/DL reciprocity assumption. Thereby, the assumption would inevitably damage the overall performance. In addition, the assumption holds only in a TDD mode but not in an FDD mode.

The second disadvantage appears when dimensions of a MIMO channel go to such a great number as T-MIMO. Firstly, a BS has to estimate the entire MIMO channels for all the coded multiplexed UEs on its SRS UL channels. The BS must estimate the channel coefficients on every single pilot for each coded multiplexed UE. Then, it must interpolate the entire MIMO channel from the estimated channel coefficients on the pilots for each UE. Secondly, it must try to pair all the active UEs and compute their common precoder. The dimensions of a typical T-MIMO system make storage and computation impossible.

The third disadvantage is due to multiple-access-interference (MAI) among coded multiplexed UEs sharing on the same SRS UL channel. MAI is inevitable. On one hand, it would limit the maximum number of the coded multiplexed UEs (capped capacity); on the other hand, it would damage the accuracy (or performance) of the channel estimation. This is why 5G has to limit the maximum number of UEs to share the same SRS UL channel. Nevertheless, the capped capacity on the SRS UL channel would represent scheduling and overhead in 6G where much more active UEs would be accommodated by one BS than 5G.

The fourth major disadvantage is due to the mobility. It is well-known that a radio channel would change significantly when a UE is moving. Sometimes, even a small position displacement would cause a LOS loss, leading to a tremendous channel change. As the SRS UL channel is shared among all active UEs and the SRS UL channel has a capacity cap, it is uneasy and power-consuming for a bunch of UEs and a BS to perform their SRS-UL channel estimations so frequently. Therefore, in practice, SRS-UL-based MU-MIMO is much more sensitive to mobility.

The last disadvantage is that a channel for channel estimation involves a DL CSI-RS channel for the UEs on the edge of the cell. In fact, UEs on the edge of a cell that uses CSI-RS would suffer from more severe performance loss.

Secondly, the 5G system makes MU-MIMO pairing and precoder matrix computation by eigenvector zero forcing (EZF), which also results in some disadvantages as follows.

The first disadvantage is due to the fact that computation related to a precoder matrix must be done for any potential UE pairing possibility of all candidate UEs. If a candidate UE is not selected for pairing on the current radio resource, a radio resource allocated to this UE (an SRS UL channel or a CSI-RS channel, and CSI feedback) and computation taken for this UE (channel estimation, singular vector decomposition (SVD), and decompression) are wasted.

The second disadvantage is due to the fact that calculation must be done for any potential UE pairing possibility of all candidate UEs, which is widely used in an EZF method. If a set of potential UE pairing is not selected (only one set of UE pairing is selected, and the rest are discarded for a certain radio time-frequency resource), computation and storage overhead related to this UE pairing possibility are wasted.

The last disadvantage is that the pairing procedure and precoder computation are sequential and bound together: for all potential UE pairing possibilities, calculation must be done for each potential UE pairing possibility, and then a set of potential UE pairing could be selected as UE pairing applied on certain radio time-frequency resources. The UE pairing applied on the certain radio time-frequency resources couldn't be decided before all the sets of potential UE pairing are tried.

Thirdly, the 5G system uses a QR decompression (QRD)-based non-uniform pilot pattern and compression.

Although the method QRD provides a good channel estimation and compression scheme with a near minimum pilot overhead and compression overhead, this is still for the purpose of a reconstruction of a channel as reliably as possible. In order to reconstruct the entire MIMO channel by a non-uniform pilot pattern (which may be represented by a matrix P), a channel space basis that is big enough should be aligned between a BS and UEs. Unfortunately, in a T-MIMO scenario, both the channel space basis and the matrix P are in a huge amount. Further, when a UE moves from one area to another, the current channel space basis and the matrix P must be updated to new ones.

In conclusion, there are many challenges and difficulties to apply the MIMO technologies, especially massive MIMO technologies, into practice, for example, how to estimate and report a MIMO channel with a reasonable overhead, how to achieve MU MIMO pairing and precoder matrix computation with a reasonable storage overhead and computation complexity, and so on. How to estimate and report the information of the MIMO channel with a reasonable overhead is a basic question from which the other questions may be solved possibly.

On that account, embodiment of the present application propose a method that focuses on a receiving apparatus that estimates and reports the information of the MIMO channel with a reasonable overhead.

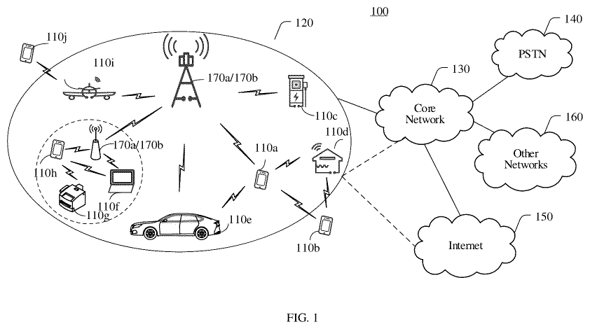

For ease of understanding of the embodiments of the present application, a communication system shown in FIG. 1 to FIG. 3 is introduced as an example to describe in detail a communication system to which the embodiments of the present application are applicable.

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

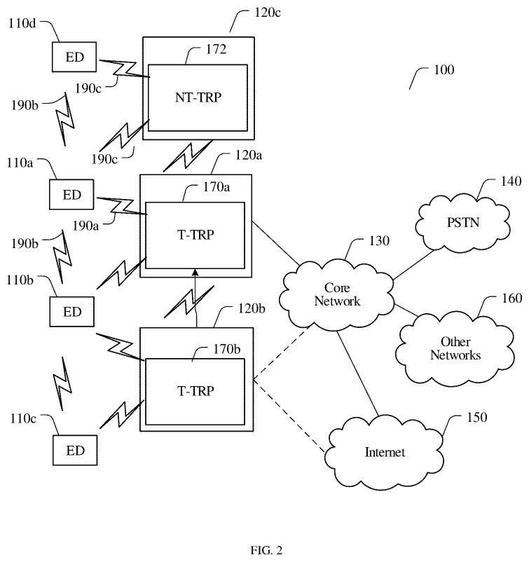

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a UE, a WTRU, a mobile station, a fixed or mobile subscriber unit, a cellular telephone, a STA, a MTC device, a PDA, a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communication.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g., beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g., in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, BBU, RRU, radio unit (RU), AAU, RRH, CU, DU, positioning node, among other possibilities. The T-TRP 170 may be macro BSs, pico BSs, relay node, donor node, or the like, or combinations thereof. The T-TRP 170 may refer to the forging devices or apparatus (e.g., communication module, modem, or chip) in the forgoing devices.

The CU (or CU-control plane (CP) and CU-user plane (UP)), DU or RU may be known by other names in some embodiments. For example, in open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g., BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g., in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g., in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

MIMO technology allows an antenna array of multiple antennas to perform signal transmissions and receptions to meet high transmission rate requirements. The above ED 110 and T-TRP 170, and/or NT-TRP use MIMO to communicate over the wireless resource blocks. MIMO utilizes multiple antennas at the transmitting apparatus and/or receiving apparatus to transmit parallel wireless signals over the wireless resource blocks. MIMO may beamform parallel wireless signals for reliable multipath transmission over a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained greater attention from academia and industry. In the large-scale MIMO system, the T-TRP 170 and/or NT-TRP 172 are generally configured with more than ten antenna units (such as 128 or 256), and serve dozens of the ED 110 (such as 40). A large number of antenna units of the T-TRP 170 and/or NT-TRP 172 can greatly increase the degree of spatial freedom of wireless communication, greatly improve the transmission rate, spectrum efficiency and power efficiency, and eliminate the interference between cells to a large extent. The increased number of antennas allows each antenna unit to be smaller in size with a lower cost. Using the degree of spatial freedom provided by the large-scale antenna units, the T-TRP 170 and/or NT-TRP 172 of each cell can communicate with many ED 110 in the cell on the same time-frequency resource, thus greatly increasing the spectrum efficiency. A large number of antenna units of the T-TRP 170 and/or NT-TRP 172 also enable each user to have better spatial directivity for uplink and downlink transmission. Thus, the transmission power of the T-TRP 170 and/or NT-TRP 172 and an ED 110 is reduced, and the power efficiency is increased. When the antenna number of the T-TRP 170 and/or NT-TRP 172 is sufficiently large, random channels between each ED 110 and the T-TRP 170 and/or NT-TRP 172 can approach orthogonality. The interference between the cell and the users and the effect of noise can be eliminated. The plurality of advantages described above enable large-scale MIMO systems to have good prospects for application.

A MIMO system may include a receiving apparatus connected to a receive (Rx) antenna, a transmitting apparatus connected to transmit (Tx) antenna, and a signal processor connected to the transmitting apparatus and the receiving apparatus. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

In the present application, a central device may be network nodes 170a or 170b in FIG. 1, and a user device may be one of EDs 110a-110j in FIG. 1; or a central device may be one of T-TRP 170a-170b and NT-TRP 172 in FIG. 2, and a user device may be one of EDs 110a-110d in FIG. 2; or a central device may be T-TRP 170 or NT-TRP 172 in FIG. 3, and a user device may be ED 110 in FIG. 3.

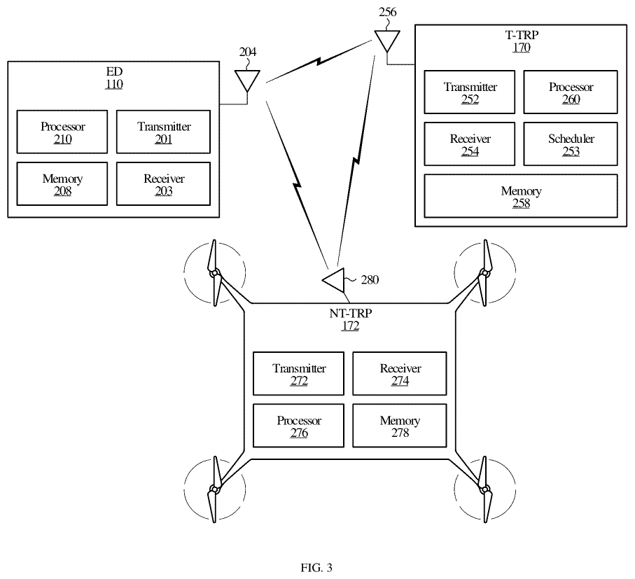

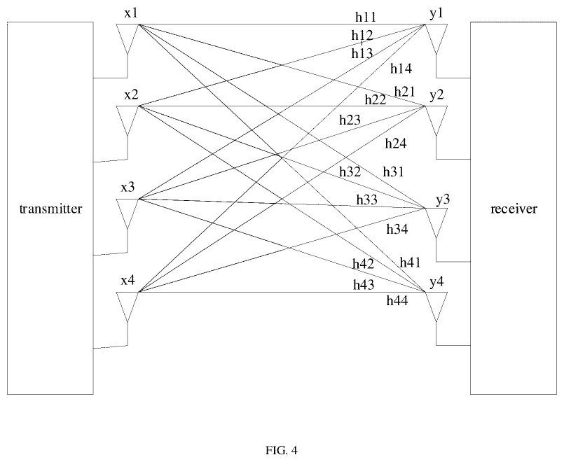

FIG. 4 is an example of a channel model of a MIMO system. A transmitting apparatus is connected to four Tx antennas, x1 to x4, a receiving apparatus is connected to four Rx antennas, y1 to y4, and a transmission channel may be formed between each Tx antenna and each Rx antenna. For example, an RF signal transmitted through x1 may be received by y2 through channel h21. The RF signal transmitted through x3 may be received by y1 through channel h13.

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, a reference signal sent by a transmitting apparatus may be used to track a change in the time domain and/or frequency domain of a channel, so as to reconstruct or restore a received signal. The reference signal may also be referred to as a pilot signal, a reference sequence or the like, and is described as a reference signal in the following for ease of understanding. The reference signal includes, for example, a channel state information-reference signal (CSI-RS), a sounding reference signal (SRS), a demodulation reference signal (DMRS), phase track reference signals (PT-RS), or cell reference signals (CRS). The reference signals listed above are merely examples, and shall not constitute any limitation on this application. This application does not exclude the possibility that other reference signals are defined in a future protocol to implement the same or similar function.

To facilitate understanding of the embodiments of this application, the CSI-RS is described in detail by example below. The CSI-RS is mainly used for downlink channel estimation corresponding to a physical antenna port. For example, a receiving apparatus (i.e., a user device) may perform channel estimation on each physical antenna port based on a CSI-RS sent by a transmitting apparatus (i.e., a central device), to feedback channel state information (CSI) based on a channel estimation result. The CSI may include related information such as a channel quality indicator (CQI), a precoding matrix indicator (PMI), a layer indicator (LI), and a rank indicator (RI). The CSI is used to reconstruct or precode the downlink channel. In some embodiments, a process in which the central device obtains CSI may include: sending, by the central device, a reference signal to the UE; obtaining, by the UE, an estimated CSI value according to the received reference signal; selecting, by the UE, a precoding vector from a codebook according to the estimated CSI value; feedback, by the UE, index of the precoding vector to the central device; and determining, by the central device, a CSI reconstruction value with reference to the index of the precoding vector. The CSI reconstruction value can be a CSI closest to the true value of the CSI that can be obtained by the central device.

In an embodiment, a transmitting apparatus maps a sequence of reference signals to certain physical resources, and transmits the reference signals over the certain physical resources. The sequence of reference signals and the physical resources are known to both the transmitting apparatus and the receiving apparatus receiving the reference signals. Thus, the receiving apparatus could perform channel estimation based on the known sequence of reference signals and the received signals.

A transmitting apparatus may map a sequence to physical resources to transmit reference signals. The physical resources may include multiple resource elements, where the resource elements are the physical resources allocated for transmission of the reference signals. For example, the resource elements are with the common resource blocks allocated for physical downlink shared channel (PDSCH) transmission when DM-RSs are transmitted.

Positions of physical resources of reference signals may be referred to as reference signal patterns or pilot patterns. The positions of the physical resources are generally described through at least one of the following dimensions: time dimension, frequency dimension, or spatial dimension.

The time dimension could be represented by one or more time domain resource units. A time domain resource unit may include, but is not limited to, a symbol, an orthogonal frequency division multiplexing (OFDM) symbol, and a slot. In some embodiments, the time domain unit may be represented by a symbol index, an OFDM symbol index, or a slot index.

The frequency dimension could be represented by one or more frequency domain resource units. A frequency domain resource unit may include, but is not limited to, a subcarrier or a subband. In some embodiments, the frequency domain unit may be represented by a subcarrier index or a subband index. In some embodiments, the frequency domain unit may also be represented by a resource element (RE) index, a resource block (RB) index, or a resource block group (RBG) index. An RE includes a symbol in a time domain and a subcarrier in a frequency domain, and an RE index could be used to indicate a position of a subcarrier. An RB includes a slot in the time domain and 12 consecutive subcarriers in the frequency domain. An RB index could be used to indicate positions of 12 subcarriers. An RBG consists of a group of RBs, and an RBG index could be used to indicate positions of a group of subcarriers.

The spatial dimension could be represented by one or more spatial domain resource units. A spatial domain resource unit may be represented by an antenna port. In the embodiments of this application, an antenna port may be a Tx antenna. The antenna port may be identified by an antenna port index.

To facilitate understanding of the embodiments of this application, in the following exemplary description, a symbol index is used to represent a position of a time domain resource unit, a subcarrier index is used to represent a position of a frequency domain resource unit, and an antenna port index is used to represent a position of a spatial domain resource unit.

A process of channel estimation described above is merely an example for description, and shall not constitute any limitation on this application. Processes of channel estimation are known in conventional technology and, for brevity, detailed descriptions of the specific processes are omitted herein.

The receiving apparatus could be an ED (i.e., a user device) and the transmitting apparatus could be a T-TRP or NT-TRP (i.e., a central device), or the receiving apparatus could be a T-TRP or NT-TRP (i.e., a central device) and the transmitting apparatus could be an ED (i.e., a user device). In some embodiments, the transmitting apparatus could be a central device and the receiving apparatus could be a user device when the reference signals in these embodiments are downlink (e.g., CSI-RS). The transmitting apparatus could be a user device and the receiving apparatus could be a central device when the reference signals in these embodiments are uplink (e.g., SRS). While one transmitting apparatus could transmit reference signals to one or more receiving apparatus, the following embodiments focus on the methods between one transmitting apparatus and one receiving apparatus for the sake of simplicity; these examples are not intended to limit the scope of the application.

Hereinafter, embodiments of the present application will be described in detail with reference to the accompanying drawings.

The method proposed by the present application can be used in a T-MIMO system where there is a larger number of antenna ports and a larger bandwidth for a transmitting apparatus and a receiving apparatus. The method can also be applied to other MIMO system (for example, a 5G MIMO system), or a single antenna system, which is not limited in the present application.

In the following, a T-MIMO radio channel will be used as an example to describe the solution proposed by the present application, and the present application will abbreviate the T-MIMO radio channel into a radio channel or a channel. Note that the present application can be applied to great-dimensional signal space other than T-MIMO.

Generally speaking, the present application proposes a method for communications that focuses on how a receiving apparatus estimates and reports information of a DL MIMO channel with a reasonable overhead in a MIMO system. Besides, the proposed solution also helps to solve the above listed disadvantages in the prior art such as the 5G system.

In more details, the present application includes improvements on the following aspects:

(1) The UL SRS RS and DL CSI RS are used for channel estimation in the prior art such as 5G system, and DL reference signals are measured or estimated based on assumption of UL/DL channel reciprocity. In contrast, DL reference signals may be used in some embodiments of the present application, and the DL MIMO channels are estimated by the UEs including the UEs on the edge of the cell with the DL reference signals transmitted by the BS. The proposed method by the present application makes no assumption of UL/DL channel reciprocity.

In the prior art, for example, in 5G system, the UEs transmit the UL SRS so that the BS can estimate UL MIMO channels between the BS and a plurality of the UEs. Because received pilots from the UEs on the edge of the cell may be too weak to be measured by the BS, and UEs on the edge of a cell may receive DL CSI RS transmitted by the BS to measure the DL MIMO channels and reports the channel estimation to the BS. The BS would use the measured or estimated UL MIMO channels as the estimation of the DL MIMO channels based on assumption about UL/DL channel reciprocity in a TDD mode. Therefore, the solution of the 5G system may merely support the TDD mode. Besides, the UL/DL channel is not always reciprocal, for example, the UL/DL channel is not reciprocal if radio frequency (RF) and intermediate frequency (IF) parts are considered.

In contrast, DL reference signals may be used in some embodiments of the present application, the DL MIMO channels are estimated by the UEs including the UEs on the edge of the cell with the DL reference signals transmitted by the BS. The proposed method by the present application makes no assumption of UL/DL channel reciprocity, and t could support both TDD MU-MIMO and FDD-MU-MIMO.

Besides, in present application, there is no performance lose and no discrimination against the UEs on the edge of a cell.

Moreover, in 5G system, in order for BS to measure more than one UE simultaneously, a coded multiplexing scheme is used over the pilots allowing more than one UEs to mask their pilots with different codes to share the same pilot positions. In 5G system, the coded multiplexing scheme on UL channel is designed to accommodate up to 16 UEs. If there are more than 16 UEs requiring to share the UL channel, new pilot positions have to be consumed. As a result, the 5G system has a capacity for a UL channel to measure a number of UEs simultaneously.

In contrast, since a CSI-RS DL channel can be naturally shared among definite number of UEs simultaneously in the solution proposed by the present application, the solution proposed by the present application has no limitation on the capacity for a DL channel shared by the UEs.

(2) pairing and precoder matrix computation can be decoupled; further, pairing or grouping would take place before SVD channel decomposition is conducted. It means that only selected UEs would be informed to report its compressed channel estimation information to the BS for the final common precoder matrix computation. Parallelism is achieved between pairing trials and precoder computation. Besides, in some embodiments of the present application, the channel estimation of the DL MIMO channel may not be an absolute estimation but a relative estimation. The relative estimation may be performed based on a new concept “reference channel” proposed by the present application, which will be descried in detail in the following embodiments of the present application. The relative estimation and feedback of the relative estimation makes the storage and computation in a massive MIMO system is possible, and reduce significantly the overhead in terms of the storage, computation, feedback and so on related to the pairing and the precoder matrix computation.

(3) The present application uses a channel space basis U to project (or compress) the channel estimation information of a DL channel into an equivalent low-dimensional space representation. Therefore, UE could feedback a highly compressed channel estimation information to the BS, consuming several-order less than CSI compression in 5G system.

(4) A concept “channel data sample” is proposed by the present application. The channel space basis U may be obtained based on some common characteristics among channels within nearby area, which could be learned or acquired from the channel data samples. A radio channel consists of a determinist part and a stochastic part, and the determinist part depends on the common characteristics. Therefore, when a UE moves from one area to another, the channel space basis U may not need to be updated, and only the stochastic part needs to be updated. The overhead of updating the channel space basis U is reduced.

(5) In some embodiments of the present application, UE may report a highly compressed channel estimation information of a DL channel to the BS. The BS wouldn't decompress the highly compressed channel estimation information but keep using the compressed channel state information to complete all the following operations including SVD-based MIMO channel decomposition, EZF-based pairing and precoder matrix computation, thus, much storage and computation complexity could be saved.

(6) UE would estimate a DL MIMO channel by a CSI-RS channel with a super-sparse non-uniform pilot pattern rather than 5G CSI-RS DL channels with a uniform pilot pattern. The non-uniform pilot pattern of the present application requires several-order lower pilot density than 5G's uniform one.

Compared to that the uniform pilot pattern used in 5G system, the super-sparse non-uniform pilot pattern proposed by the present application reduces the overhead in terms of radio resources allocated for the pilots.

(7) pairing can be simplified to support high mobility.

A moving UE may keep reporting information of a DL channel to the BS during the UE is in a high mobility scenario, the information of the DL channel may be an index of a reference channel, and the reference channel may be a “representative” of the DL channel. The index of the reference channel may be used for pairing at the BS sides, which simplifies pairing to support high mobility.

The improvements listed herein will be explained in the embodiment below.

In embodiments of the present application, the UE may receive reference signals for channel estimation from the BS, and therefore, the UE is referred to as a receiving apparatus, and the BS is referred to as a transmitting apparatus.

In order to achieve these improvements, the present application mainly relies on two fundamentals that are environment-dependent MIMO channels and equivalent low-dimension signal space.

FIG. 5 is a flow chart of a method (500) for communications proposed by an embodiment of the present application. The method (500) specifically includes the following steps 510˜520. The steps of the method (500) may be performed correspondingly by a transmitting apparatus or a receiving apparatus, or a chip installed in the transmitting apparatus or the receiving apparatus. The method may be applied in a MIMO system which includes one transmitting apparatus and one or more receiving apparatuses. Hereinafter, one transmitting apparatus and one receiving apparatus are taken as an example to describe the method of the embodiments. The transmitting apparatus may be a BS, and the receiving apparatus may be a UE.

At step 510, the receiving apparatus obtains information of K reference channel(s) and common information.

The information of the K reference channel(s) is related to an environment parameter set (which may be also referred to an environment), the common information is used for determining information of a downlink (DL) channel, and K is a positive integer.

For example, the receiving apparatus obtains the information of the K reference channel(s) and the common information based on channel measurement. The reference channel will be described in detail in the following embodiments.

The DL channel may be a channel between the transmitting apparatus and the receiving apparatus, or a first channel may be regarded as a channel between a Tx antenna at the transmitting apparatus side and a Rx antenna at the receiving apparatus side. Or, from another point of view, the DL channel may be a channel on which the receiving apparatus may perform channel measurement (i.e. channel estimation).

A reference channel may be data or information of a channel that may exist between the transmitting apparatus and the receiving apparatus.

In an implementation, the information of the DL channel includes index(es) of first reference channel(s), and a distance between the DL channel and a first reference channel is less than or equal to a threshold. The threshold may be predefined, configured by the network, or defined in the communication standards. In some embodiments, the information of the DL channel may indicate one first reference channel, for example, the information of the DL channel indicates an index of the one first reference channel.

At step 520, the receiving apparatus transmits feedback information based on the common information and the information of the K reference channel(s). Correspondingly, the transmitting apparatus receives the feedback information.

The feedback information may include the information of the DL channel. For example, the information of the DL channel determined by the receiving apparatus may be the index(es) of the first reference channel(s).

The feedback information is no longer a channel estimation result itself but information of the first reference channel(s) that may be representative of the DL channel. Since the index of the first reference channel consumes less overhead compared with the channel estimation result, a large amount of overhead in terms of feedback of the information of the DL channel is reduced.

In an embodiment, the K reference channel(s) is K channel data sample(s) selected from M channel data samples, or the K reference channel(s) is K compressed channel data sample(s) corresponding to the K reference channel(s) from M channel data samples. The M channel data samples are related to the environment parameter set, and the K channel data sample(s) is related to the environment parameter set because the K channel data sample(s) is selected from the M channel data samples. The environment parameter set including one or more environment parameters may represent an environment (i.e. a wireless environment). The environment may be a generalized definition, and the environment parameter set includes one or more environment parameters used for representing the environment. In other words, the environment parameter set may be represented as one or more environment parameters. The one or more environment parameters may include one or more of: spatial area, frequency band, a duplexing mode (e.g., time division duplex or frequency division duplex; half duplex or full duplex), time or time duration, weather, data traffic (e.g. traffic mode or non-traffic mode. The traffic mode refers to periods during which data traffic exceeds a certain threshold. The non-traffic mode refers to periods during which data traffic is below or equal to the certain threshold.), precoder, and so on.

The channel data sample may be data or information that represents a channel state of a channel, and the channel data sample may be measured or accumulated by a communication apparatus (for example, the transmitting apparatus or the receiving apparatus), or virtually generated by a simulator.

In some embodiments of the present application, new concepts of the channel data sample and the reference channel are introduced. For better understanding of the two new concepts, some related knowledge and technologies are introduced herein.

A radio channel between the transmitting apparatus and the receiving apparatus is mainly dominated by the environment where the transmitting apparatus and the receiving apparatus are located. Inherent relevance between the environment and the radio channel is an embodiment in ray-tracing (RT) channel models that generate channel responses in function of a line of sight (LOS) and a non-line of sight (NLOS) (reflections and/or diffusions), that is, rays or a cluster of rays, plus some randomness. According to the RT channel model, a radio channel may include a determinist part due to the RT and a stochastic part due to random events. In an implementation of the present application, the determinist part is some common characteristics among channels within nearby areas, which could be learned or acquired and represented as the common information.

A radio channel may result from a multiple-path fading channel, which is more or less affected by its surroundings. Radio rays or clusters (or groups) of rays of the radio channel may be subjected to reflections and diffusions of radio electric magnetic waves on surrounding physical surfaces, edges, or corners of buildings, roads, buses, tracks, persons, and so on, which may result in a plurality of radio paths at the receiving apparatus side. Some surfaces, edges, and corners are immobile (buildings, bridges, poles, roads, pavements etc.), whereas others are moving (e.g. moving vehicles etc.), which may result into a timing variation (or fading) on a plurality of radio paths. Most moving entities in practice may follow certain trajectories with certain velocities (e.g. vehicles only drive on the road), which may be also regulated by a surrounding environment consisting of some immobile entities. Therefore, a radio channel may be closely related to an environment where the transmitting apparatus and the receiving apparatus are located.

A plurality of radio channels that are located within a same environment may share some commonality. The commonality may be regarded as common environment prior-knowledge about the radio channels. The common environment prior-knowledge may be represented in various forms including but not limited to any one of:
Alternative #1: by one or a plurality of statistic functions with arguments;
Alternative #2: by one or a plurality of matrixes; and
Alternative #3: by one or several trained artificial intelligence (AI) models (for example, DNNs).

The common environment prior-knowledge of a number of radio channels between the transmitting apparatus and the plurality of receiving apparatus that are located in the same environment may be learned or acquired. The acquired common environment prior-knowledge related to the environment may be validated, persistent, and useful for a radio channel between the transmitting apparatus and a receiving apparatus that enters into the environment for a period of time after the common environment prior-knowledge is acquired. Thereby, the acquired common environment prior-knowledge may represent a spatial and timing-persistent commonality, which is relevant to the said environment.

The receiving apparatus may obtain a plurality of pieces of common environment prior-knowledge, each piece of which is related to one environment. In some embodiments of the present application, the common environment prior-knowledge can be learned or acquired from M channel data samples related to a same environment (that is a same environment parameter set), where M is a positive integer. Alternatively, the common environment prior-knowledge may be called as the common information in some embodiments of the present application.

Different environments may be overlapping or on-overlapping in a physical spatial area; or different environments may be either overlapping or non-overlapping between UL and DL; or different environments may be either overlapping or non-overlapping across frequency bands. In the embodiments, the “spatial area” may relate to an area in spatial domain, and the “physical spatial area” may relate to an area or a space that actually exists.

Some examples referring to the receiving apparatus obtaining common information are given below.

Example #1: the receiving apparatus may obtain a piece of common information that is related to an environment.

Example #2: the receiving apparatus may obtain two pieces of common information. A first piece of common information is related to radio channels that correspond to a first spatial area, and a second piece of common information is related to radio channels that correspond to a second spatial area. The two spatial areas may be either overlapped or non-overlapped, adjacent or distanced, and the spatial areas may be designated as sectors.

Example #3: the receiving apparatus may obtain two pieces of common information. A first piece of common information is related to radio channels that correspond to a first physical spatial area, and a second piece of common information is related to radio channels that correspond to a second physical spatial area. The first spatial area may include the second spatial area.

Example #4: the receiving apparatus may obtain two pieces of common information. A first piece of common information is related to radio channels between the transmitting apparatus and the receiving apparatus to which the receiving apparatus may apply a first Rx decoder, and a second piece of common information is related to radio channels between the transmitting apparatus and the receiving apparatus to which the receiving apparatus may apply a second Rx decoder. The receiving apparatus may apply two different Rx decoders to a transmitting apparatus.

Example #5: the receiving apparatus may obtain two pieces of common information. A first piece of common information is related to radio channels in a first frequency band between the transmitting apparatus and the receiving apparatus, and a second piece of common information is related to radio channels in a second frequency band between the transmitting apparatus and the receiving apparatus. The two frequency bands may be overlapped or non-overlapped and may be adjacent or distanced.

Example #6: the receiving apparatus may obtain two pieces of common information. A first piece of common information is related to UL radio channels between the transmitting apparatus and the receiving apparatus, and a second piece of common information is related to DL radio channels between the transmitting apparatus and the receiving apparatus.

Besides, the common information obtained by the receiving apparatus may be a combination of the examples above. Moreover, the common information may vary over the time.

Furthermore, any piece of common information mentioned above may be acquired from a number of channel data samples (which may be also called as channel samples, data sample set, learning data set, or training data set, etc.), for example, M channel data samples, which may be accumulated and prepared in the following ways, including but not limited to any one of the following ones:

Alternative #1: the channel data sample may be measured and then accumulated by the receiving apparatus in the history. For example, the receiving apparatus may estimate the DL channel by CSI-RS to obtain the channel data samples.

Alternative #2: the channel data samples may be virtually generated by a digital environment simulator, and the digital simulator may be called as digital twin of the target environment.

In some implementations, the channel data samples may be preferably accumulated in a way that combines the alternatives above dynamically, which is not limited herein.

In some embodiments of the present application, the channel data samples may be accumulated, stored, and processed optionally at one or more receiving apparatus, especially the one or more receiving apparatus have powerful computation capability and large storage space.

In some embodiments of the present application, common information related to an environment (that is, an environment parameter set) may be represented in various forms, for example, statistic-based, matrix-based and AI-based (for example, DNN-based) as mentioned above. Further, the matrix-based common information includes a channel space basis-based, orthogonal matrix-based, or non-orthogonal matrix-based common information, and so on.

In an embodiment, the common information may be represented by statistic values about a radio channel, for example, the statistic values may be calculated by utilizing statistic-based functions or empirical formulas. For example, the statistic values include coherent time, coherent frequency, root-mean-square (RMS) delay and so on.

In yet another embodiment, the common information may be based on matrix and/or AI, and may be learned or acquired from channel data samples. The channel data samples contain a plurality of radio channel data samples, which may include channel status, channel measurements, channel coefficients, and so on.

If the common information is matrix-based, the following generic or principal steps may be taken on a device such as the transmitting apparatus (which may be regarded as a central device, for example, the BS), a powerful receiving apparatus (for example, one or more UEs) or a remote data center. Hereinafter, a “device” is used to represent any one of the devices including the transmitting apparatus, the receiving apparatus and the remote data center. The common information may be computed with the following steps:

Step #1: the device may vectorize the channel data samples if a channel data sample is in a form of a matrix or tensor (for example, a MIMO channel data sample is a three-dimensional tensor, RE-by-TxAnt (i.e. Tx antenna port)-by-RxAnt (i.e. Rx antenna port)), where the device may apply a fixed vectorization order to all the channel data samples, and save or remember the vectorization order.

FIG. 6 shown an example to vectorize a tensor-formed MIMO channel data sample according to an embodiment of the present application. Herein is an example to vectorize a three-dimensional tensor into a vector. A MIMO channel sample is represented as a three-dimensional tensor [symbol] represented by N_{RE}-by-N_{Rx}-by-N_{Tx}, and is vectorized into a column vector h₁ represented by N_{RE}N_{Rx}N_{Tx}-by-1, as shown in FIG. 6 by a vectorization order: RE, then Tx, then Rx, N_{RE} represents the number of resource elements (RE), N_{Tx} represents the number of Tx antenna ports at the transmitting apparatus side, and N_{Rx} represents the number of Rx antenna ports at the receiving apparatus side. As a first MIMO channel data sample in tensor is [symbol] represented by N_{RE}-by-N_{Rx}-by-N_{Tx}, the device may vectorize it in an order: RE, then Tx, then Rx, into h₁ (represented by N_{dim}-by-1, N_{dim}=N_{RE}N_{Tx}N_{Rx}), first column-wise vector; as a second MIMO channel data sample in tensor is [symbol] represented by N_{RE}-by-N_{Rx}-by-N_{Tx}, the device may vectorize it in the same order into h₂ (represented by N_{dim}-by-1, N_{dim}=N_{RE}N_{Tx}N_{Rx}), a second column-wise vector; and so on until the device vectorizes all the M MIMO channel data samples in tensor into column-wise vectors.

Step #2: the device may juxtapose all the column-wise vectorized channel data samples into a matrix and then decompose the matrix. If the channel data samples are vectorized into column-wise vectors, the juxtaposition may be done row by row. The two juxtapositions are mathematically equivalent. In the following discussion, column-wise vectorization and column-wise juxtaposition is used. The decomposition may be to compute a basis of the matrix. The basis may be called as channel space basis to represent the common environment prior-knowledge acquired from the channel data samples. The decomposition may be SVD so that the generated channel space basis is an orthonormal matrix or unitary matrix. The decomposition may be in other method so that the generated channel space basis is a non-orthogonal matrix.

In an example, M (s.t. N_{dim}>>M>rₑₙᵥ) column-wise vectorized MIMO channel data samples are column-wisely juxtaposed into a N_{dim}-by-M matrix: [symbol] =[h₁ h₂ . . . ], and the order of the channel data samples doesn't matter.

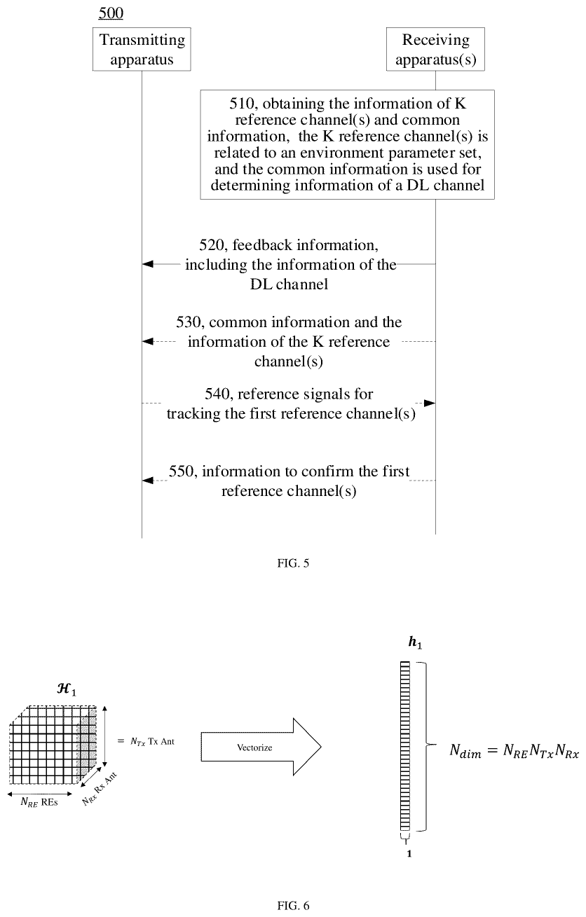

FIG. 7 shows an example of column-wisely juxtaposing column-wised vectorized channel data samples into a matrix according to an embodiment of the present application. According to FIG. 7, the decomposition is a rank-reduced SVD: [symbol] =UΣV^{H}, U and V are unitary matrixes or orthonormal matrixes, and Σ is a diagonal matrix. If h is set as a column-wise vector, U represented by N_{dim}-by-rₑₙᵥ is the channel space basis and represents common information that all the M MIMO channel data samples share. As mentioned above, the target environment is defined by where and how the M MIMO channel data samples are accumulated and prepared. In this sense, an environment (or an environment parameter set) may be regarded as channel data samples.

Note that, in some embodiments of the present application, we set h as a column-wise vector, and without losing generality, if h is set as a row-wise vector like

$$𝕙 = [ \begin{matrix}{h}_{1} \\ {h}_{2} \\ ⋮\end{matrix} ] ,$$

then [symbol] =UΣV^{H}, V is the channel space basis and represents a common environment prior-knowledge of channel data samples. Mathematically both are exactly the same. In the following discussion, we will use the column-wise vector as examples.

With the channel space basis, any vectorized channel data sample h can be represented (i.e. compressed, encoded, or projected) by a weighted linear combination of the columns of the channel space basis U, where the weighted coefficients are called as spectrum coefficient vector c: h=Uc, and c is a rₑₙᵥ-by-1 vector. Although the channel space basis U is a thin and tall matrix, that is, N_{dim}>>rₑₙᵥ, the spectrum coefficient vector c (which represented by rₑₙᵥ-by-1) is much smaller than h (which represented by N_{dim}-by-1), and the spectrum coefficient vector c is mathematically an equivalent low-dimensional space of h. It allows that some storages, representations, or calculations on h can be equivalently performed on c.

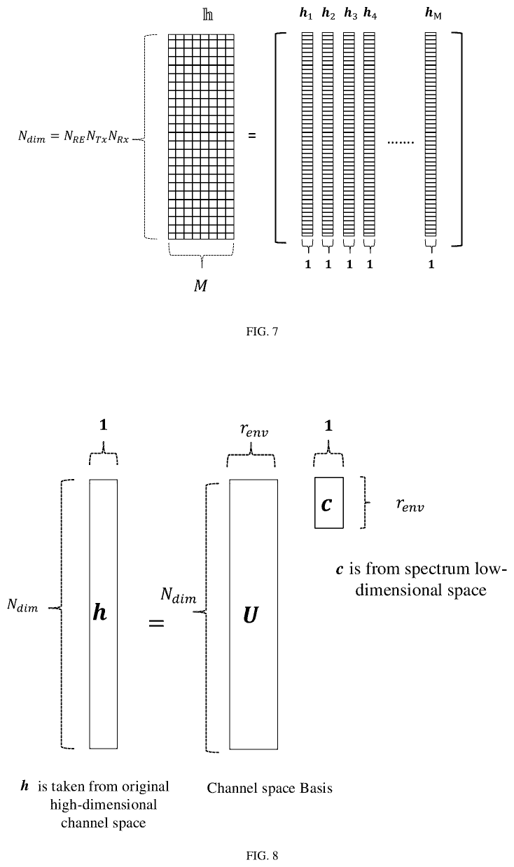

FIG. 8 shows an example of an equivalent low-dimensional space. Optionally and preferably, the device that computes channel space basis U from a plurality of channel data samples may project each vectorized channel data sample h by inverse of the channel space basis U⁻¹ into an equivalent low-dimensional space representation c, which may be named as low-dimensional spectrum coefficient representation: c=U⁻¹h, where c is a rₑₙᵥ-by-1 vector. If U is an orthonormal matrix or unitary matrix, then the inverse of the channel space basis U⁻¹ is Hermitian transpose of the channel space basis (that is, U⁻¹=U^{H}): c=U^{H}h. Because c contains all the principal information of h, the device may project spectrum coefficient representation back to the original channel data space: h=Uc, as illustrated in FIG. 8. The device may prefer saving channel data samples in form of low-dimensional space representation c with a channel space basis U than channel data samples h.

The receiving apparatus may select a set of K channel data sample(s) from the M channel data samples, [symbol] =[h₁ h₂ . . . h_{M}], and use the set of K channel data sample(s) as a set of K reference channel(s) described above. Alternatively, the reference channel can also be called as a mooring channel or an anchor channel, which is not limited. The receiving apparatus may keep updating the set of the K reference channel(s); the receiving apparatus may retire some old reference channels and enlist some new ones; the receiving apparatus may keep or change the size (i.e. K) of the set. The receiving apparatus may segment the set of the K reference channel(s) into several overlapping or non-overlapping subsets, wherein the segmentation may be any one of:

Alternative #1: the receiving apparatus may randomly select K channel data sample(s) from M channel data sample(s) as a first sub-set, and then continue to randomly select K′ (K′≤K) channel data sample(s) from the set as a second subset.

Alternative #2: the receiving apparatus may use some segmentation algorithms such as K-means, random walk or Gaussian mixture model (GMM) to select first K₁ data samples from M channel data samples as a first set, and to select second K₂ data samples from M channel data samples as a second set. Optionally, the receiving apparatus may select one data sample into both the first set and the second set.

Alternative #3: the receiving apparatus may score the “distances” among M channel data samples, and then may select the K most-degreed channel data samples. The “degree” is a graph theory term that indicates how many connections a node on a graph has. A node with a higher degree is called as a “hub” node on a graph. A node with a higher degree means to be more typical or representative. Note that, each node on the graph represents a channel data sample in alternative #3.

In whichever alternative, the receiving apparatus may select K channel data sample(s) into a set [symbol] : [symbol] =[h_{Set(1)} h_{Set(2)} . . . h_{Set(K)}], where Set(k) returns an original index of the selected channel data sample in [symbol] described above. Optionally, the receiving apparatus may not select K channel data sample(s) from the channel data samples in the [symbol] but may re-measure new channel data samples by means described above.

The following embodiments will focus on solutions regarding a single set of K reference channels unless it is explicitly claimed. For those skilled in the art, the embodiments can be easily extended to multiple sets of reference channels without any efforts.

Back to step 520, the feedback information may include the information of the DL channel.

In an implementation, the information of the DL channel may be an index of a first reference channel, and a distance between the DL channel and the first reference channel is less than or equal to a threshold.

The first reference channel is a reference channel included in the K reference channel(s), and there may be one or more first reference channels. The distance between the first channel and any of the first reference channels is less than or equal to the threshold, for example, a first threshold.

Note that a concept of a distance between two channels is proposed in the embodiments of the present application. Specifically, in the embodiments of the present application, the distance may be a distance between a reference channel and the first channel. The first channel in some embodiments of the present application may be a physical channel measured by the receiving apparatus, or the first channel may be a channel between the transmitting apparatus and the receiving apparatus.

The receiving apparatus may measure or score the distance between the first channel and each of the K reference channel(s), determine the first reference channel, and report the index of the first reference channel to the transmitting apparatus. The receiving apparatus may measure or score the distance in an equivalent low-dimensional space. Hereinafter, a procedure for calculating the distance between two channel data samples is given, which may be applied to the distance calculation between the first channel and the reference channel.

FIG. 9 shows an example of a scoring function for measuring a distance between two channels on equivalent low-dimensional space. Hereinafter, the two channels may be descried with two channel data samples as examples.

As shown in FIG. 9, in case that the device represents the common information by channel space basis U, the device may project a channel data sample (hᵤₛₑᵣ) (N_{dim}-by-1, N_{dim}=N_{RE}N_{Tx}N_{Rx}) into a low-dimensional spectrum space, that is, a spectrum coefficient vector (i.e. cᵤₛₑᵣ) (rₑₙᵥ-by-1), by the channel space basis U, hᵤₛₑᵣ=Ucᵤₛₑᵣ and cᵤₛₑᵣ=U⁻¹hᵤₛₑᵣ. In particular and preferably, when the channel space basis U is orthonormal or unitary, hᵤₛₑᵣ=Ucᵤₛₑᵣ and cᵤₛₑᵣ=U^{H}hᵤₛₑᵣ. Therefore, the device may score or measure the “distance” or “similarity” or “correlation” metric between any two channel data samples (hᵤₛₑᵣ₁ and hᵤₛₑᵣ₂) by a scoring or measuring function δ_{1,2}=d(hᵤₛₑᵣ₁,hᵤₛₑᵣ₂), which returns a “distance”, “similarity”, or “correlation” scalar metric between two input channel data samples, hᵤₛₑᵣ₁ and hᵤₛₑᵣ₂. If d( ) is equivariant, then δ_{1,2}=d(hᵤₛₑᵣ₁,hᵤₛₑᵣ₂)=d(Ucᵤₛₑᵣ₁,Ucᵤₛₑᵣ₂)=Ud(cᵤₛₑᵣ₁,cᵤₛₑᵣ₂), meaning that the scoring or measuring can be equivalently taken on the low-dimensional spectrum space. The device may use d(cᵤₛₑᵣ₁,cᵤₛₑᵣ₂) to represent a distance between two channel data samples (hᵤₛₑᵣ₁ and hᵤₛₑᵣ₂). The scoring or measuring function d( ) may be equivariant and may include but be not limited to the following operations:
Alternative #1: Euclidean function;
Alternative #2: inner product between two vectors; and so on.

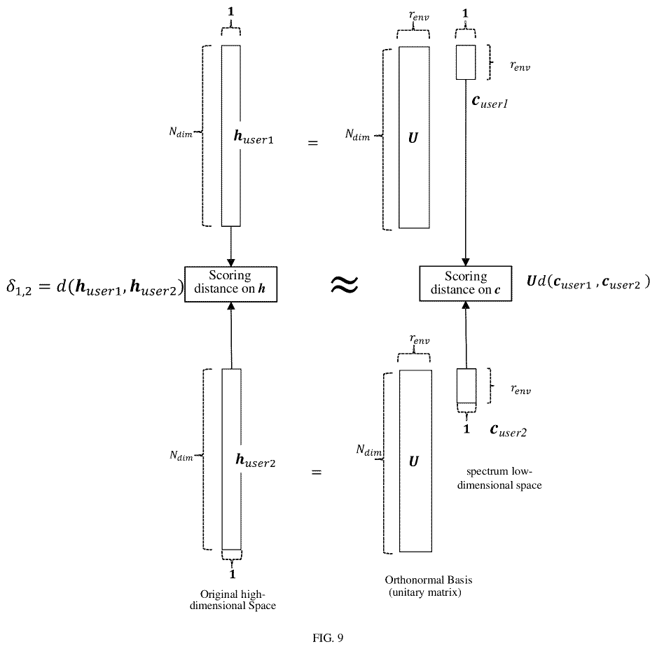

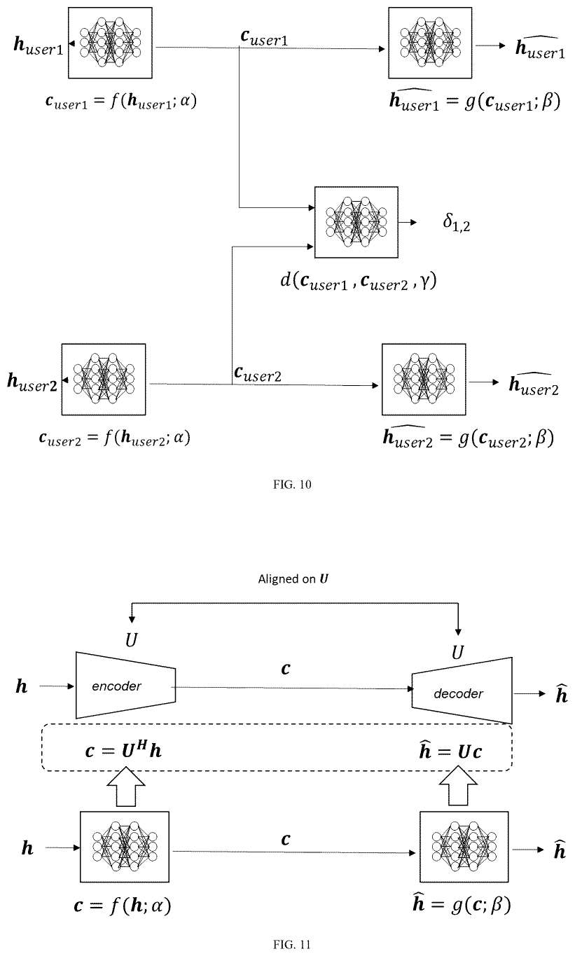

FIG. 10 shows an example of a DNN-based scoring function for measuring a distance between two channel data samples on equivalent low-dimensional latent space. As shown in FIG. 10, in case that the device represents the common information by ƒ(:;α) mentioned above, the device may use a scoring or measuring function on the latent layer output c=ƒ(h;α), in which the scoring function may be realized by another DNN (δ_{1,2}=d(cᵤₛₑᵣ₁, cᵤₛₑᵣ₂, γ)), where γ may be parameters in neurons needed to be trained.

As in the T-MIMO scenario the dimension (N_{dim}) of the reference channel may be very massive, in some implementations, the receiving apparatus may further compress the set of K reference channel(s) [symbol] . According to what has been described above, the transmitting apparatus may project the set of the K reference channel(s) [symbol] into a low-dimensional spectrum coefficient vector by c_{Set(k)}=U^{H}h_{Set(k)}, k=1, 2, . . . , K. The receiving apparatus may store the set of the reference channel(s) in low dimensional spectrum space as [symbol] =[c_{Set(1)} c_{Set(2)} . . . c_{set(K)}], where c_{Set(k)} is a rₑₙᵥ-by-1 vector instead of in the original space [symbol] =[h_{Set(1)} h_{Set(2)} . . . h_{Set(K)}].

In an implementation, the information of the K reference channel(s) described in the step 510 may include the original K reference channel(s), that is to say, the receiving apparatus transmits the set of the K reference channel(s) [symbol] =[h_{Set(1)} h_{Set(2)} . . . h_{Set(K)}] to the transmitting apparatus. Optionally, the receiving apparatus may transmit part of the set of the K reference channel(s) for reducing overhead in terms of radio resources for transmitting a reference channel, especially in a case that the transmitting apparatus determines that a “representative” channel of the first channel may be part ones of the K reference channel(s).

The K reference channel(s) may include a second reference channel, and the information of the K reference channel(s) further includes one or more of:
a set of matrixes Q that are related to the second reference channel, where each of the matrixes Q is an orthonormal projection matrix obtained by QR decomposition of the second reference channel; and
a matrix R that is related to the second reference channel, where the matrix R is an up-triangular square matrix obtained by QR decomposition of the second reference channel.

More details about the set of matrixes Q and the matrix R will be introduced in the followings.

N_{dim} (dimension of both h_{Set(k)} and the channel space basis U) of TMIMO is too big for the transmitting apparatus or the receiving apparatus to store all the [symbol] and channel space basis U. The h_{Set(k)} and U may be further compressed in some embodiments of the present application.

In some embodiments of the present application, the transmitting apparatus may pair a number of candidate receiving apparatuses according to their DL channels for MU-MIMO DL transmission. The transmitting apparatus may decide to pair them on a plurality of consecutive REs into resource block group (RBG). For example, 1 RBG contains 4 consecutive RBs, that is, 48 consecutive REs. The transmitting apparatus may pair the candidate receiving apparatuses for individual RBG, which means that the pairing results on the first RBG may be different from the pairing results on the second RBG.

The transmitting apparatus may select some or all MIMO receiving apparatuses from the candidate receiving apparatuses into first paired group; the transmitting apparatus may compute first common Tx precoder for the first paired group for the first RBG. The transmitting apparatus may select some or all MIMO receiving apparatuses from the candidate MIMO receiving apparatuses into second paired group; the transmitting apparatus may compute second common Tx precoder for the second paired group for the second RBG. The first paired group and the second paired group may be the same or different.

The transmitting apparatus is taken as an example to describe a process of the QR decompression.

After the transmitting apparatus decides a size of RBG (N_{REsinRBG}), the transmitting apparatus may further compress the set of the reference channels [symbol] or compressed [symbol] . The transmitting apparatus may firstly access a channel data sample h_{Set(k)}, and de-vectorize (tensorize) into N_{RE}-by-N_{Tx}-by-N_{Rx} [symbol] by the inversed vectorization order, [symbol] =tensorize (h_{Set(k)}). From the 1-st RE to the N_{RE}-th RE, each RE of the Set(k)-th reference channel has a N_{Tx}-by-N_{Rx} H_{Set(k),RE} (= [symbol] [RE,:,:]) MIMO channel. Since the first N_{REsinRBG} REs (H_{Set(k),RE}, RE=1, 2, . . . , N_{REsinRBG}) consist into the first RBG, the transmitting apparatus may average a N_{Tx}-by-N_{Rx} MIMO channel on the first RBG for the Set(k)-th reference channel:

$${H}_{Set ( k ) , RBG ( 1 )} = \frac{{\sum }_{RE = 1}^{RE = {N}_{REsinRBG}} {H}_{Set ( k ) , RE}}{{N}_{REsinRBG}} = \frac{{\sum }_{RE = 1}^{RE = {N}_{REsinRBG}} tensorize ( {h}_{Set ( k )} ) [ RE , : , : ]}{{N}_{REsinRBG}} ;$$

then the device may average a N_{Tx}-by-N_{Rx} MIMO channel on the second RBG for the user device Set(k):

$${H}_{Set ( k ) , RBG ( 2 )} = \frac{{\sum }_{RE = {N}_{REsinRBG} + 1}^{RE = 2 {N}_{REsinRBG}} {H}_{Set ( k ) , RE}}{{N}_{REsinRBG}} = \frac{{\sum }_{RE = {N}_{REsinRBG} + 1}^{RE = 2 {N}_{REsinRBG}} tensorize ( {h}_{Set ( k )} ) [ RE , : , : ]}{{N}_{REsinRBG}} ;$$

until all the RBGs are done for the Set(k)-th reference channel.

Since h_{Set(k)} can be represented as linear combination of the columns of the channel space basis U by the spectrum coefficient vector

$${c}_{Set ( k )} , {h}_{Set ( k )} = {Uc}_{Set ( k )} = {\sum }_{i = 1}^{{r}_{env}} {c}_{Set ( k )} [ i ] U [ : , i ] ,$$

a linear tensorization can be

$${ℋ}_{Set ( k )} = {\sum }_{i = 1}^{{r}_{env}} {c}_{Set ( k )} [ i ] tensorize ( U [ : , i ] ) ->$$

$${H}_{Set ( k ) , RBG ( 1 )} = \frac{{\sum }_{RE = 1}^{RE = {N}_{REsinRBG}} {\sum }_{i = 1}^{{r}_{env}} {c}_{Set ( k )} [ i ] tensorize ( U [ : , i ] ) [ RE , : , : ]}{{N}_{REsinRBG}} = \frac{{\sum }_{i = 1}^{{r}_{env}} {c}_{Set ( k )} [ i ] {\sum }_{RE = 1}^{RE = {N}_{REsinRBG}} tensorize ( U [ : , i ] ) [ RE , : , : ]}{{N}_{REsinRBG}} .$$

Denote

$${u}_{i , l} = \frac{{\sum }_{RE = ( l - 1 ) \cdot {N}_{REsinRBG}}^{RE = l \cdot {N}_{REsinRBG}} tensorize ( U [ : , i ] ) [ RE , : , : ]}{{N}_{REsinRBG}}$$

as N_{Tx}-by-N_{Rx} matrix that is the i-th column of channel space basis U tensorized and averaged on the l-th RBG. So, it is unnecessary to store H_{Set(k),RBG1}, because it can be computed by c_{Set(k)} and u_{i,1}, i=1, 2, . . . , rₑₙᵥ. As all the reference channels share the channel space basis U, u_{i,l}, i=1, 2, . . . , rₑₙᵥ, l=1, 2, . . . , N_{RBG} is shared as well:

$${H}_{Set ( k ) , RBG ( l )} = {\sum }_{i = 1}^{{r}_{env}} {c}_{Set ( k )} [ i ] {u}_{i , l} .$$

Moreover, H_{Set(k),RBG(l)} can be QRD (i.e. QR decompression) into a N_{Tx}-by-N_{Rx} orthonormal projection matrix Q_{Set(k),l} and a N_{Rx}-by-N_{Rx} up-triangular square matrix R_{Set(k),l}: H_{Set(k),RBG(l)}=Q_{Set(k),l}R_{Set(k),l}. By using a projection matrix Q_{Set(k),l} to compress u_{i,l}:

$${R}_{Set ( k ) , l} = {{Q}_{Set ( k ) , l}}^{H} {H}_{Set ( k ) , RBG ( l )} = {{Q}_{Set ( k ) , l}}^{H} {\sum }_{i = 1}^{{r}_{env}} {c}_{Set ( k )} [ i ] {u}_{i , l} = {\sum }_{i = 1}^{{r}_{env}} {c}_{Set ( k )} [ i ] {r}_{i , l , Set ( k )} where$$

$${r}_{i , l , Set ( k )} = {{Q}_{Set ( k ) , l}}^{H} {u}_{i , l} is a {N}_{Rx} - by - {N}_{Rx}$$

square matrix.

Optionally and preferably, the transmitting apparatus and the receiving apparatus may store the set of K reference channels in a RBG-sensitive way; for example, the Set(k)-th reference channel may be stored as:
One rₑₙᵥ-by-1 vector c_{Set(k)};
N_{RBG} N_{Tx}-by-N_{Rx} projection matrix Q_{Set(k),l} where l=1, 2, . . . , N_{RBG};
N_{RBG}×rₑₙᵥ N_{Rx}-by-N_{Rx} square matrix r_{i,l,Set(k)} where i=1, 2, . . . , rₑₙᵥ and l=1, 2, . . . , N_{RBG}.

Preferably and optionally, the transmitting apparatus and the receiving apparatus may store the set of K reference channels in a RBG-sensitive and rank-reduced way; for example, the Set(k)-th reference channel may be stored as:
the first r′ₑₙᵥ (r′ₑₙᵥ<rₑₙᵥ) elements of c_{Set(k)};
N_{RBG}×r′ₑₙᵥ (r′ₑₙᵥ<rₑₙᵥ) N_{Rx}-by-N_{Rx} square matrix r_{i,l,Set(k)} where i=1, 2, . . . , r′ₑₙᵥ and l=1, 2, . . . , N_{RBG}.

The information of the K reference channel(s) includes one or more of:
a data sample in time domain of each of the K reference channel(s);
a data sample in frequency domain of each of the K reference channel(s);
multipath information of each of the K reference channel(s); and
an initial phase of a third reference channel corresponding to a first subband and phase offset(s) of fourth reference channel(s) corresponding to second subband(s) relative to the initial phase, where K≥2, and the K reference channels include the third reference channel and the fourth reference channel(s).

The third reference channel and the fourth reference channel are named only for distinguishing the reference channels described in the embodiments of the present application, which should not limit the scope of protection of the present application.

Alternatively, the multipath information of a reference channel may include one or more of:
a number of paths, angle in a horizontal direction, angle in a vertical direction, delay, doppler, power, amplitude and phase for each of the paths, where the angel in the horizontal direction or the angel in the vertical direction may include a departure angel or an arrival angle.

In yet another implementation, the information of the K reference channel(s) may include compressed K reference channel(s) corresponding to the K reference channel(s) respectively. Specifically, a set of the compressed K reference channel(s) [symbol] =[h_{Set(1)} h_{Set(2)} . . . h_{Set(K)}] may be compressed as [symbol] =[c_{Set(1)} c_{Set(2)} . . . c_{Set(K)}], where C_{Set(k)} is a rₑₙᵥ-by-1 vector. Besides, if there are several sets or subsets of reference channel(s) mentioned above, all the sets or the subsets are based on a same basis U.

Optionally, when the receiving apparatus transmits the compressed reference channel c_{Set(k)}, k=1, 2, . . . , K, the receiving apparatus may transmit the first r′ₑₙᵥ (r′ₑₙᵥ<rₑₙᵥ) elements of c_{Set(k)} instead of all the rₑₙᵥ elements of c_{Set(k)}, saving a lot of DL payload by sending [symbol] =[c′_{Set(1)} c′_{Set(2)} . . . c′_{Set(K)}] and an indicator of r′ₑₙᵥ. Note that, rₑₙᵥ represents the number of elements included in c_{Set(k)}, and r′ₑₙᵥ represents a number less than rₑₙᵥ, where rₑₙᵥ and r′ₑₙᵥ are positive integers. From another point of view, r′ₑₙᵥ represents the number of elements in the compressed reference channel c′_{Set(K)}.

In some implementations, the method (500) may further include a step 530.

At step 530, the receiving apparatus transmits the common information and the information of the K reference channel(s). Correspondingly, the transmitting apparatus receives the common information and the information of the K reference channel(s).

Alternatively, at step 530, the receiving apparatus may transmit projection of the channel space basis U to a predefined matrix instead of the channel space basis U. That is, at step 530, the receiving apparatus may transmit the projection of the channel space basis U to a predefined matrix and the information of the K reference channel(s).

In an implementation, there are several ways for the receiving apparatus to transmit the information of the K reference channel(s) to the transmitting apparatus, which may include but be not limited to any one of:
K set(s) of the matrixes Q that correspond to the K reference channel(s) respectively, where each of the K set(s) is related to a corresponding reference channel; and
K matrix(es) R that correspond to the K reference channel(s) respectively, where each of the K matrix(es) is related to a corresponding reference channel.

Therefore, there are several ways for the receiving apparatus to transmit the common information and the information of the K reference channel(s) at the step 530.

For example, the receiving apparatus transmits the channel space basis U and the information of the K reference channel(s) to the transmitting apparatus.

For another example, the receiving apparatus transmits the projection of the channel space basis U to a predefined matrix and the information of the K reference channel(s) to the transmitting apparatus.

For another example, the receiving apparatus transmits the projection of the channel space basis U to a predefined matrix and the K set(s) of the matrixes Q corresponding to the K reference channel(s) respectively to the transmitting apparatus.

For another example, the receiving apparatus transmits the projection of the channel space basis U to a predefined matrix and the K matrix(es) R corresponding to the K reference channel(s) respectively to the transmitting apparatus.

The above is an introduction to the matrix-based representation of the common information.

In yet another embodiment, the common information is based on the AI. If the common information is based on the AI, the generic or principal steps may be taken on a device, for example, the receiving apparatus (for example, the UE), to learn the piece of common information. The device may use a non-linear approximation method to approach the channel space basis U acquired by channel data samples, in which the non-linear approximation method may be a DNN model or other AI models.

FIG. 11 shows an example of DNN implementation approaches a channel space basis U. DNN-based representation of the common information is an approximation to linear channel space basis U. The device may use a non-linear encoding function, c=ƒ(h;α) (α is an tunable parameter which may be called as a first parameter of the encoding DNN function) to approximate c=U⁻¹h and a non-linear decoding function, h=g(c;β) (β is the tunable parameter which may be called as a second parameter of the decoding DNN function), to approximate h=Uc, where the non-linear encoding function and the non-linear decoding function may be concatenated into ĥ=g(ƒ(h;α);β) and may be realized by a DNN with α and β as tunable neurons. In the DNN-like implementation, the device may choose the output of one latent layer (c=ƒ(h;α)) for an equivalent low-dimensional space of the input h. In other words, the output of the latent layer approaches to equivalent low-dimensional space, i.e. the spectrum coefficient representation c.

The device may train the DNN by a learning goal to minimize MSE ∥h₁−g(ƒ(h₁;α);β)∥² for all the M training data samples (h₁, h₂, . . . , h_{M}) in a stochastic gradient descendent (SGD) way to tune the parameters α and β. The trained parameters α and β which represent the common information are transmitted by the receiving apparatus to the transmitting apparatus.

After the transmitting apparatus receives the information of the K reference channel(s) from the receiving apparatus, the transmitting apparatus may transmit reference signals to the receiving apparatus for tracking the K reference channel(s).

Thereby, the method may further include a step 540 and a step 550.

At step 540, the transmitting apparatus transmits reference signals to the receiving apparatus for tracking the first reference channel(s). Correspondingly, the receiving apparatus performs channel measurement (or reference signal measurement, or channel estimation) to track the first reference channel(s).

Specifically, the receiving apparatus performs channel measurement on the DL channel and obtains an estimation result of the DL channel. The receiving apparatus determines whether the first reference channel(s) needs to be updated based on the estimation result of the DL channel and the information of the K reference channel(s). For example, if a distance between the DL channel and a certain first reference channel is greater than or equal to a threshold, the first reference channel(s) may need to be updated.

The transmitting apparatus and the receiving apparatus may be clearly configured with a same pilot pattern which may be represented by the matrix P. Some examples are given below. The transmitting apparatus may transmit the matrix U to the receiving apparatus. There are other alternatives including but not limited to any one of the following ones:

Alternative #1: both the transmitting apparatus and the receiving apparatus may follow a legacy uniform pilot pattern defined in a wireless standard; for example, every resource block (RB) has one pilot and pilots are constantly placed across the RB direction in 5G specification; both the transmitting apparatus and the receiving apparatus may use a minimum controlling payload to align the parameters about the uniform pilot pattern; both the transmitting apparatus and the receiving apparatus may configure or inform each other to have the channel space basis U; the transmitting apparatus may send the pilots on the positions that the matrix P may indicate, and the receiving apparatus may receive the pilots on the positions that the matrix P may indicate.

Alternative #2: both the transmitting apparatus and the receiving apparatus may follow a random function that generates a random pilot pattern in terms of a given random seed(s), wherein the random function may be defined in a wireless standard; both the transmitting apparatus and the receiving apparatus may use a minimum controlling payload to align the parameters about the random function and random seed and other arguments; both the transmitting apparatus and the receiving apparatus may configure or inform each other to have the channel space basis U; and the transmitting apparatus may send the pilots on the positions that the matrix P may indicate.

Alternative #3: both the transmitting apparatus and the receiving apparatus may follow a generative function that generates a pilot pattern in terms of channel space basis U, wherein the generative function may be defined in a wireless standard; both the transmitting apparatus and the receiving apparatus may use a minimum controlling payload to align the parameters about the generative function and other arguments; both the transmitting apparatus and the receiving apparatus may configure or inform each other to have the channel space basis U; and the transmitting apparatus may send the pilots on the positions that the matrix P may indicate.

Alternative #4: both the transmitting apparatus and the receiving apparatus may follow a generative AI model that generates a pilot pattern; both the transmitting apparatus and the receiving apparatus may use a minimum controlling payload to align the parameters about the generative AI model and other arguments; both the transmitting apparatus and the receiving apparatus may configure or inform each other to have the channel space basis U; the transmitting apparatus may send the pilots on the positions that the matrix P may indicate, and the receiving apparatus may receive the pilots on the positions that the matrix P may indicate.

The transmitting apparatus may transmit reference signals for tracking the reference channel, and the reference signals may be generated based on the channel space basis U or the matrix P.

In an implementation of the present application, the transmitting apparatus and the receiving apparatus may use a non-uniform and sparse pilot pattern, meaning Nₚᵢₗₒₜ<<N_{dim}, which can reduce a pilot overhead. For example, the matrix P mentioned above represents a pilot pattern, each row of which has only one “1” to indicates positions to be used as pilots.

Referring to FIG. 12, FIG. 12 shows an example of a pilot pattern matrix P. Each row of the matrix P has only one “1” to indicates positions to be used as pilots. The transmitting apparatus may transmit pilots on these positions indicated by the matrix P and the receiving apparatus may estimate the channel coefficients (which may be represented by ĥₚᵢₗₒₜ_{ᵤₛₑᵣ}) on these positions indicated by the matrix P. Optionally, the matrix P may be explicitly or implicitly in various forms but essentially it may be in a form of a matrix.

The receiving apparatus may estimate the radio channel (which may be represented by ĥᵤₛₑᵣ) from the received pilots (i.e. ĥₚᵢₗₒₜ_{ᵤₛₑᵣ}) and then project the estimated radio channel (i.e. ĥᵤₛₑᵣ) to the low-dimensional spectrum coefficient vector ĉᵤₛₑᵣ; the receiving apparatus may transmit the low-dimensional spectrum coefficient vector ĉᵤₛₑᵣ to the transmitting apparatus; and the transmitting apparatus may receive and project the low-dimensional spectrum coefficient vector ĉᵤₛₑᵣ back to the original channel space by the channel space basis U: ĥᵤₛₑᵣ=Uĉᵤₛₑᵣ.

In some embodiments, according to the channel space basis U, a near-optimal non-uniform pilot pattern can be computed by pivot QRD on U: UP=QR. The several “strongest” pivots in P (in typical pivot QRD, the pivots are ordered in terms of their importance or contributiveness) would indicate the most important or contributive positions to place reference signals (or pilots) for the reconstruction purpose.

At step 550, the receiving apparatus transmits information to confirm the first reference channel(s).

The K reference channel(s) may be one reference channel or at least two reference channels, which is not limited.

In some embodiments, K=1, and the information to confirm a first reference channel may be information indicating “yes” or “no”. In an implementation, the first reference channel does not need to be updated in a case that the information to confirm the first reference channel indicates “yes”. In another implementation, the first reference channel needs to be updated in a case that the information to confirm the first reference channel indicates “no”. For example, the information to confirm the first reference channel may be one bit, and two values of “1” and “0” of the one bit is configured to indicate these two cases.

In some other embodiments, K≥2, the K reference channel(s) may be at least two reference channels, and the information to confirm the first reference channel(s) may indicate one or more indexes corresponding to one or more first reference channels from the K reference channels respectively. For example, the information to confirm the first reference channel(s) includes index(es) of first reference channel(s) that could be an “representative” of the DL channel. In these embodiments, the information to confirm the first reference channel(s) may indicate one or more index(es) corresponding to one or more first reference channels.

The receiving apparatus performs channel measurement with the reference signals and transmits the information to confirm the first reference channel(s) to the transmitting apparatus, which may be regarded as a procedure of tracking the first reference channel(s). By tracking the first reference channel(s), the transmitting apparatus gets the information of the DL channel by receiving index(es) of the first reference channel(s) from the receiving apparatus, and the first reference channel(s) is the representative of the DL channel.

Some detailed examples of the method (500) are given below. The common information is represented based on the channel space basis U, and the receiving apparatus may use the information to confirm the first reference channel(s) to report one reference channel (that is, the first reference channel), which will not be repeated in the following examples.

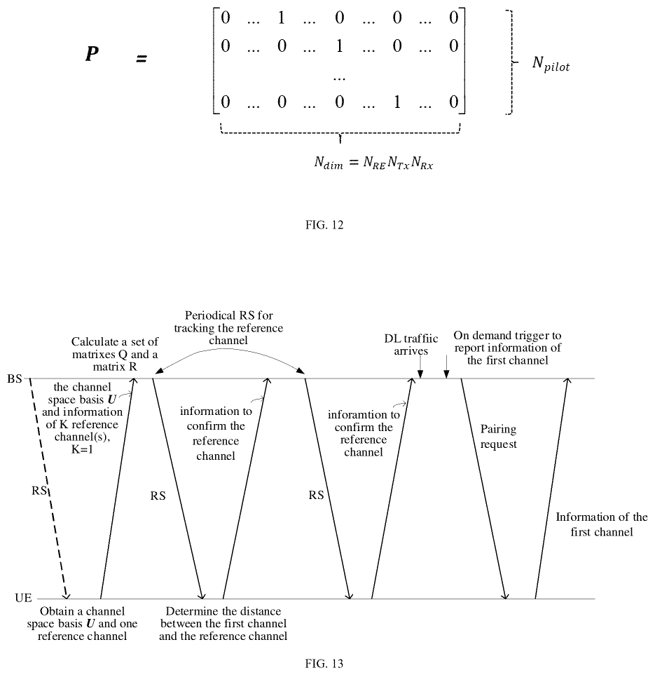

FIG. 13 is an example of the method (500) according to an embodiment of the present application. The transmitting apparatus transmits reference signals to the receiving apparatus in a period of time. In this period of time, the receiving apparatus performs channel estimation (or reference signal measurement) with the reference signals to obtain a channel space basis U and K reference channel(s). The receiving apparatus may transmit the channel space basis U and the information of the K reference channel(s) to the transmitting apparatus. The information of the K reference channel(s) may be represented by a spectrum coefficient vector ĉⱼ, j=1, 2, . . . , K. Note that, the K reference channel(s) may be regarded as K first reference channel(s) in this example. The transmitting apparatus may calculate a set of matrixes Q and a matrix R related to a second reference channel based on information of the second reference channel. The second reference channel may be any one of the K reference channel(s). Therefore, K sets of the matrixes Q and K matrixes R may be obtained at the transmitting apparatus. The K sets of the matrixes Q may be used for MU pairing, and the K sets of the matrixes Q and the K matrixes R may be used for precoder matrix computation.

After receiving the channel space basis U and the information of the K reference channel(s), the transmitting apparatus may transmit reference signals for tracking the first reference channel(s). Correspondingly, the receiving apparatus performs channel estimation on a first channel (that is, the DL channel) between the transmitting apparatus and the receiving apparatus to obtain an estimation result ĥᵤₛₑᵣ (which may be regarded as a first channel estimation), and then the receiving apparatus may transmit information to confirm the first reference channel(s).

Hereinafter, one reference channel is taken as an example to describe the following embodiments. The above information of the K reference channel(s) may be represented by ĉ₁. The information to confirm the first reference channel(s) is determined based on the estimation result ĥᵤₛₑᵣ and the information of the reference channel. The receiving apparatus uses the channel space basis U to compress the estimation result ĥᵤₛₑᵣ to obtain the spectrum coefficient vector ĉᵤₛₑᵣ:ĉᵤₛₑᵣ=U^{H}ĥᵤₛₑᵣ. On this basis, the receiving apparatus determines a distance between the first channel and the reference channel by a scoring function. The spectrum coefficient vector ĉ₁ and the spectrum coefficient vector ĉᵤₛₑᵣ are input parameters of the scoring function, and the distance is an output of the scoring function. If the distance between the first channel and the reference channel is less than a threshold, the receiving apparatus transmits the information to confirm the reference channel (that is, the first reference channel). The reference channel is a representative of the first channel. For example, the information to confirm the reference channel may be one bit, and a value of “1” or “0” indicates confirmation of the reference channel. For another example, the information to confirm the reference channel may be an index of the reference channel. If the distance between the first channel and the reference channel is greater than a threshold, it means that the reference channel could no longer be the “representative” of the first channel. The receiving apparatus may select a new reference channel and inform the transmitting apparatus. That is, the reference channel needs to be updated.

Note that, because the information to confirm the reference channel is used to inform the transmitting apparatus that the reference channel could be a representative of the first channel, and the information of the reference channel is received by the transmitting apparatus from the receiving apparatus in advance, the information to confirm the reference channel in FIG. 13 could be regarded as feedback of the channel estimation of the first channel.

As an example, the feedback of the channel estimation before the MU pairing is shown for two times in FIG. 13. The feedback of the channel estimation may be periodical, and a period of the feedback may be determined by the network, or the period of the feedback is predefined, which is not limited in the embodiments of the present application. Note that, the channel space basis U may not be obtained by performing the channel measurement only once, and what is shown in FIG. 13 is mere an example. The channel measurement is only one way to obtain the channel space basis U, and some other alternatives have been described in the above embodiments.

The reference channel(s) reported to the transmitting apparatus is a “representative” of the first channel, and only the selected receiving apparatus in the MU pairing would be informed to report channel estimation of the first channel to the transmitting apparatus for the precoder matrix computation. If the receiving apparatus is selected in the MU pairing, the transmitting apparatus transmits a pairing request to the receiving apparatus. Note that the pairing request is used to inform the receiving apparatus to report the channel estimation for the precoder matrix computation. Optionally, a name of a message used for informing the receiving apparatus to report the channel estimation should be not limited, and the name of the “pairing request” may be replaced with other ones. Hereinafter, the “pairing request” is used as an example. If the pairing request is received by the receiving apparatus, the receiving apparatus performs the channel estimation on the first channel and reports the channel estimation (which may be regarded as a second channel estimation) to the transmitting apparatus. It can be seen that the pairing and the precoder matrix computation are decoupled in some embodiments of the present application. After the MU pairing is determined, the information of the DL channel (that is, the first channel) determined by the receiving apparatus may be the channel estimation information, for example, the channel estimation information may indicate a distance between the first channel and the first reference channel. In some implementations, the transmitting apparatus may transmit the pairing request to the receiving apparatus after DL traffic arrives.

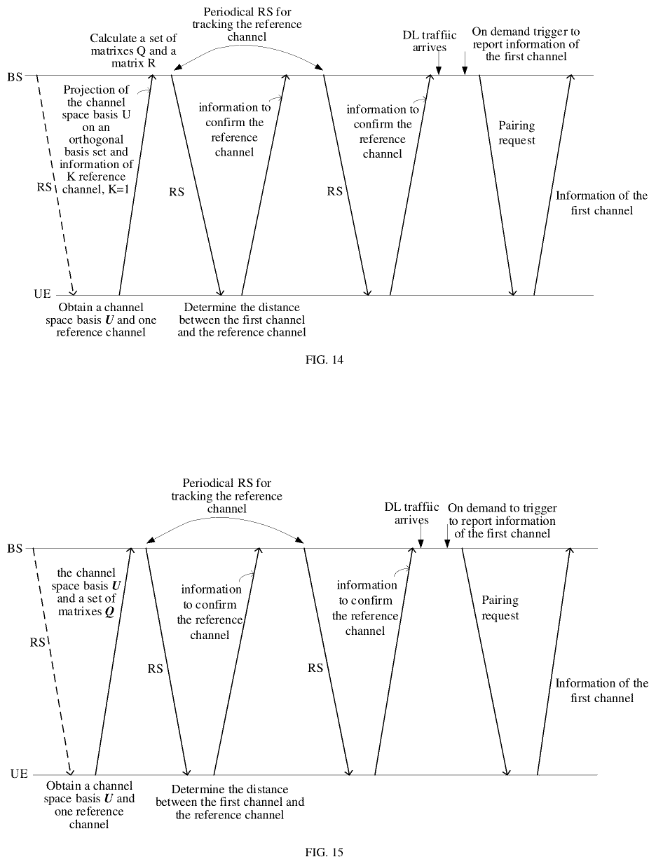

FIG. 14 is an example of the method (500) according to an embodiment of the present application. The receiving apparatus obtains common information and information of K reference channel(s). As an example, K=1. The receiving apparatus obtains the information of one reference channel and the common information based on channel measurement (or reference signal measurement) in a period of time. The receiving apparatus transmits the common information and the information of the reference channel to the transmitting apparatus. In this example, the common information is transmitted by transmitting projection of the channel space basis U on an orthogonal basis set. Other description of information or step shown in FIG. 14 can refer to that of the FIG. 13, which is not repeated herein.

FIG. 15 is an example of the method (500) according to an embodiment of the present application. One reference channel is taken as an example, that is, K=1. In this example, the common information is transmitted by a way of the channel space basis U, and the information of the reference channel is transmitted by a way of a set of matrixes Q which are related to the reference channel. As mentioned above, each matrix Q of the set of the matrixes Q is an orthonormal projection matrix by QR decomposition of the reference channel. Besides, the transmitting apparatus obtains the set of matrixes Q from the receiving apparatus directly. Other description of information or step shown in FIG. 15 can refer to that of the FIG. 13, which is not repeated herein.

FIG. 16 is an example of the method (500) according to an embodiment of the present application. One reference channel is taken as an example, that is, K=1. In this example, the transmitting apparatus transmits projection of the channel space basis U on an orthogonal basis set and information of the reference channel. The information of the reference channel may be a set of matrixes Q which are related to the reference channel. Other description of information or step shown in FIG. 16 can refer to that of the FIG. 13, which is not repeated herein.

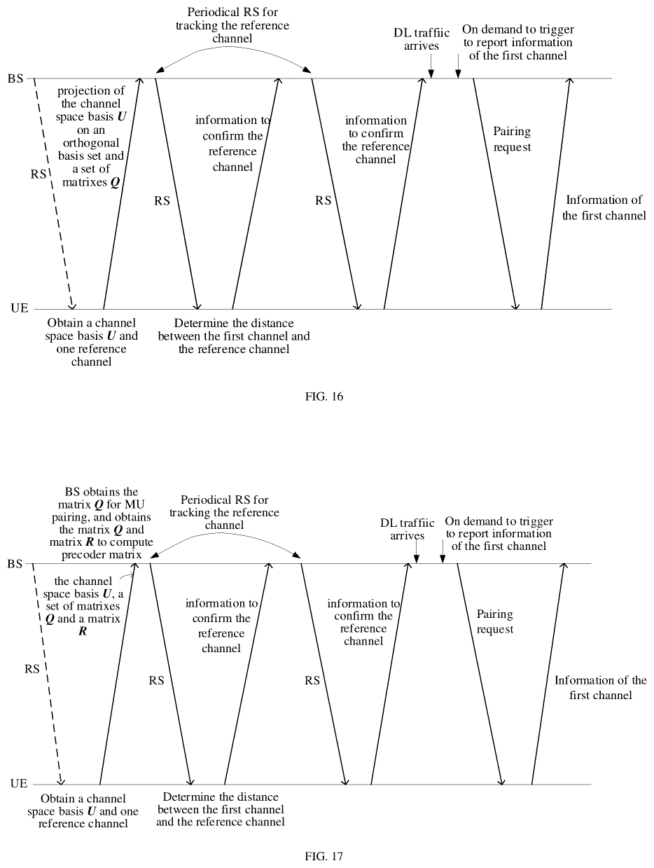

FIG. 17 is an example of the method (500) according to an embodiment of the present application. In this example, the transmitting apparatus transmits projection of the channel space basis U on an orthogonal basis set and the information of the reference channel. The information of the reference channel may be a set of matrixes Q and a matrix R which are related to the reference channel, each matrix Q of the set of the matrixes Q is an orthonormal projection matrix obtained by QR decomposition of the reference channel, and the matrix R is an up-triangular square matrix obtained by QR decomposition of the reference channel. The set of matrixes Q may be used for MU pairing, and the set of the matrixes Q and the matrix R may be used for precoder matrix computation. Other description of information or step shown in FIG. 17 can refer to that of the FIG. 13, which is not repeated herein.

In the above examples shown in FIG. 13 to FIG. 17, the reference signals for tracking the K reference channel(s) include any one of:
reference signals derived from the channel space basis U;
non-precoded reference signals; and
precoded reference signals.

Optionally, the RS for tracking the first reference channel(s) in FIG. 13 to FIG. 17 may be a uniform pilot pattern such as CSI-RS, or the RS for tracking the first reference channel(s) may be a very sparse non-uniform pilot pattern, which is not limited. If the RS for tracking the first reference channel(s) is a non-uniform and sparse pilot pattern, the non-uniform and sparse pilot pattern could be determined according to the channel space basis U. In some implementations, the CSI-RS may be non-precoded (NP) CSI-RS, or precoded CSI-RS. The very sparse RS proposed by the present application is generated based on the channel space basis U, which has been described in the above embodiments. The RS for tracking the first reference channel(s) may be transmitted in a wide band, or a subband, which is not limited.

In some embodiments of the present application, the receiving apparatus obtains information of K reference channel(s) and common information for determining information of a DL channel. The K reference channel(s) is related to an environment parameter set. The receiving apparatus reports the information of the DL channel by transmitting feedback information based on the information of the K reference channel(s) and the common information. The feedback information is no longer a channel estimation result itself but information of a reference channel that may be a representative of the DL channel, which reduces the overhead for the receiving apparatus to report information of the DL channel to the transmitting apparatus in a MIMO system.

The method proposed by the present application is described in detail above, and a communication apparatus provided by the present application will be described in detail below.

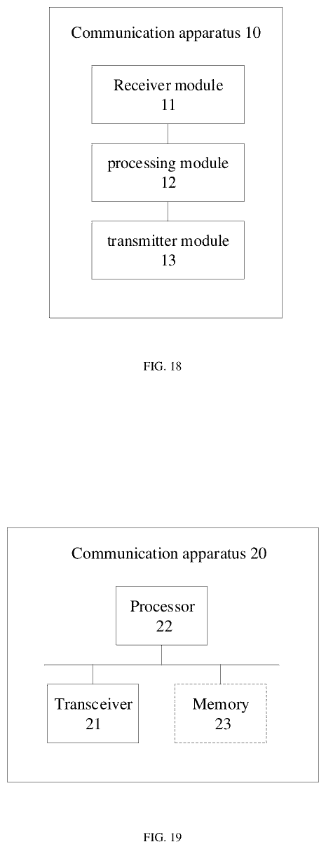

FIG. 18 is a schematic block diagram of a communication apparatus 10 according to an embodiment of the present application. As shown in FIG. 18, the apparatus 10 includes a receiver module 11, a processing module 12 and a transmitter module 13.

The processing module 12 is configured to obtain common information and information of K reference channel(s), the K reference channel(s) is related to an environment parameter set, the common information is used for determining information of a downlink (DL) channel, and K is a positive integer; and

The transmitter module 13 is configured to transmit feedback information based on the common information and the information of the K reference channel(s), the feedback information includes the information of the DL channel.

In an implementation, the transmitter module 13 is further configured to transmit the common information and the information of the K reference channel(s).

In an implementation, the processing module 12 is further configured to determine whether the first reference channel(s) needs to be updated by channel measurement.

In an implementation, the processing module 12 is further configured to: obtain the common information and the information of the K reference channel(s) based on channel measurement.

In an implementation, the processing module 12 is further configured to: obtain an estimation result of the DL channel; and determine whether the first reference channel(s) needs to be updated according to the estimation result and the information of the K reference channel(s).

The apparatus 10 in the embodiments of the present application may correspond to the receiving apparatus in any one of the embodiments of the method described above, and the operations and/or functions of the apparatus 10 are intended to implement corresponding steps of the foregoing methods. For brevity, details are not repeated herein.

Optionally, the transmitter module 13 and the receiver module 11 may be implemented by a transceiver, and the processing module 12 may be implemented by a processor.

Referring to FIG. 19, a communication apparatus 20 may include a transceiver 21. Optionally, the communication apparatus may further include a processor 22 and a memory 23. The memory 23 may be configured to store data, information, code or instructions and the like that is to be executed by the processor 22, to make the communication apparatus 20 to perform operations by the receiving apparatus in the corresponding embodiments.

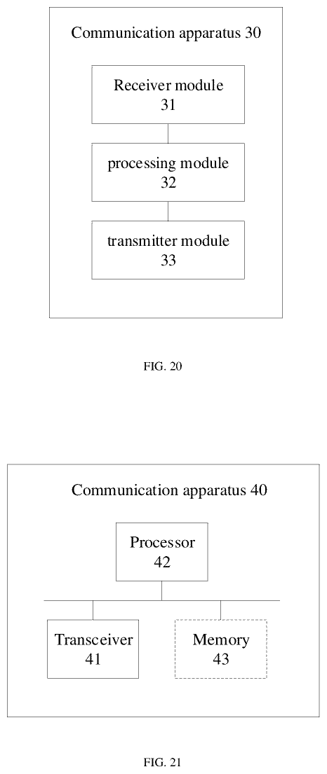

FIG. 20 is a schematic block diagram of a communication apparatus according to an embodiment of the present application. As shown in FIG. 20, the apparatus 30 includes a receiver module 31, a processing module 32, and a transmitter module 33.

The receiver module 31 is configured to receive information of K reference channel(s) and common information, the K reference channel(s) is related to an environment parameter set, the common information is used for determining information of a downlink (DL) channel, and K is a positive integer.

In an implementation, the transmitter module 33, configured to: transmit reference signals for tracking the K reference channel(s).

The apparatus 30 in embodiments of the present application may correspond to the transmitting apparatus in any one of the embodiments of the methods described above, and the operations and/or functions of the apparatus 30 are intended to implement corresponding steps of the foregoing methods. For brevity, details are not repeated herein.

Similarly, the transmitter module 33 and the receiver module 31 may be implemented by a transceiver.

Referring to FIG. 21, a communication apparatus 40 may include a transceiver 41. Optionally, the communication apparatus may further include a processor 42 and a memory 43. The memory 43 may be configured to store data, information, code or instructions and the like that is to be executed by the processor 42, to make the communication apparatus 40 to perform operations by the transmitting apparatus in the corresponding embodiments.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processor 22 or the processor 42 may be a general-purpose processor, a digital signal processor (DSP), an application-specific integrated circuit (ASIC), a field programmable gate array (FPGA), or another programmable logic device, a discrete gate or a transistor logic device, or a discrete hardware component. All methods, steps, and logical block diagrams disclosed in these embodiments of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random access memory (RAM), a flash memory, a read-only memory (ROM), a programmable read-only memory (PROM), an electrically erasable programmable memory, or a register. The storage medium is located in the memory, and the processor reads the information in the memory and completes the steps in the foregoing methods in combination with the hardware of the processor.

It may be understood that the memory 23 or the memory 43 in the embodiments of the present invention may be a volatile memory or a non-volatile memory, or may include a volatile memory and a non-volatile memory. The non-volatile memory may be a ROM, a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a RAM, and be used as an external cache. Through example but not limitative description, many forms of RAMs may be used, for example, a static random access memory (static RAM, SRAM), a dynamic random access memory (dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (enhanced SDRAM, ESDRAM), a synchronous link dynamic random access memory (synch Link DRAM, SLDRAM), and a direct rambus dynamic random access memory (direct Rambus RAM, DR RAM). The storage of the system and the method described in this specification aim to include, but are not limited to, these and any other proper storage.

An embodiment of the present application further provides a communication system. The communication system includes the communication apparatus 10 and the communication apparatus 30 according to any one of the embodiments.

An embodiment of the present application further provides a computer storage medium, and the computer storage medium may store one or more instructions for executing any of the foregoing methods.

Optionally, the storage medium may be specifically the memory 23 or 43.

An embodiment of the present application further provides a computer program product, and the computer program product may store one or more instructions for executing any of the foregoing methods.

In the embodiments of this application, “and/or” describes an association relationship between associated objects and represents that three relationships may exist. For example, A and/or B may represent the following three cases: Only A exists, both A and B exist, and only B exists. The character “/” generally indicates an “or” relationship between the associated objects. “At least one” means one or more. “At least one of A and B”, similar to “A and/or B”, describes an association relationship between associated objects and represents that three relationships may exist. For example, at least one of A and B may represent the following three cases: Only A exists, both A and B exist, and only B exists.

The technical terms such as “reference channel”, “channel data sample” may be not limited by a specific name, and may also be other names.

Besides, the use of a singular form of “a”, “an” and “the” in the embodiments of the present application and the claims appended hereto is also intended to include a plural form, unless otherwise clearly indicated herein by context.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a ROM, a RAM, a magnetic disk, an optical disc or the like.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments. In addition, functional units in the embodiments of this application may be integrated into one processing unit, or each of the units may exist alone physically, or two or more units are integrated into one unit.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

### A Method of Massive MIMO for Wireless Communication

### Technical Field

The present disclosure relates generally to wireless communications.

### Acronyms and Abbreviations

| Full Name | Acronym/Abbreviation/Initialism |
|---|---|
| MIMO | Multiple-In-Multiple-Out |
| T-MIMO | Terabit Multiple In and Multiple Out |
| NR | Next generation radio (=5G) |
| gNB | |
| BS | Base-station |
| UE | User-equipment |
| Tx | Transmitter |
| Rx | Receiver |
| SU | Single-User |
| MU | Multiple-User |
| RE | Resource Element |
| SVD | Singular Vector Decomposition |
| SNR | Signal-to-Noise Ratio |
| DL | Downlink |
| UL | Uplink |
| TDD | Time Division Duplex |
| FDD | Frequency Division Duplex |
| SRS | Sounding reference signals |
| TTI | Time Transmission Interval |
| RF | Radio Frequency |
| IF | Intermediate frequency |
| MAI | Multiple-Access-Interference |
| CSI-RS | Channel State Information Reference Signal |
| PMI | Precoding matrix index |
| RI | Rank index |
| Pivot-QRD | Pivot QR Decomposition |
| EZF | Eigen-Zero Forcing |
| MSE | Mean Square Error |
| LOS | Line of Sight |
| NLOS | Non Light of Sight |
| RT | Ray-Tracing |
| DNN | Deep Neural Network |
| RMS | root-mean-square |
| AE | AutoEncoder |
| SGD | Stochastic Gradient Descendent |

### MIMO and MU-MIMO

MIMO system has been widely deployed in modern wireless systems to improve system capacity and bandwidth efficiency by making use of space diversities among antenna ports. For example, on a given subcarrier or RE, a transceiver made of N_{Tx} Tx antenna ports and N_{Rx} Rx antenna ports consists into a N_{Tx}-by-N_{Rx} MIMO channel represented by a N_{Tx}-by-N_{Rx} complex matrix H_{UE,RE} that can be decomposed via SVD [4]: H_{UE,RE}=Z_{UE,RE}S_{UE,RE}V_{UE,RE}^{H}, where Z_{UE,RE} is a N_{Tx}-by-N_{Tx} square orthonormal matrix (s.t. Z_{UE,RE}^{H}Z_{UE,RE}=I), V_{UE,RE} is a N_{Rx}-by-N_{Rx} square orthonormal matrix (s.t. V_{UE,RE}^{H}V_{UE,RE}=I), and S_{UE,RE} is a N_{Tx}-by-N_{Rx} rectangular diagonal matrix. The rank (r_{UE,RE}) of H_{UE,RE} is no more than the smaller one between N_{Rx} and N_{Tx}, i.e. r_{UE,RE}=min(N_{Tx},N_{Rx}). Per standard SVD, if the transmitter applied a precoder matrix Z_{UE,RE}^{H} and the receiver a receiving matrix V_{UE,RE}, the N_{Tx}-by-N_{Rx} MIMO channel would turn into r_{UE,RE} independent and parallel (orthogonal) sub-channels as following mathematic expression:

$${{Z}_{UE , RE}}^{H} {H}_{UE , RE} {V}_{UE , RE} = ( {{Z}_{UE , RE}}^{H} {Z}_{UE , RE} ) {S}_{UE , RE} ( {{V}_{UE , RE}}^{H} {V}_{UE , RE} ) = {S}_{UE , RE}$$

Each sub-channel has a scale value channel response (H_{UE,RE}(i)), i.e. i-th diagonal element of S_{UE,RE} (singular value, h_{UE,RE}(i)=S_{UE,RE}(i, i)). Accordingly, SNR on the i-th sub-channel is defined as

$$\frac{{‖ {h}_{UE , RE} ( i ) ‖}^{2}}{N} ,$$

i=1, 2, . . . , r_{UE,RE}. In a wireless system, only the sub-channels whose SNRs are higher than a threshold are considered as effective for transmissions. The effective sub-channels are called as MIMO flows.

The SNR-based truncation MIMO decomposition scheme turns a standard SVD into a rank-reduced SVD one by discarding those sub-channels with SNRs lower than threshold(s): H_{UE,RE}≈Z_{UE,RE}S_{UE,RE}V_{UE,RE}^{H} (reduced SVD in [4]), where Z_{UE,RE} is a N_{Tx}-by-r_{UE,RE} orthonormal matrix (s.t. Z_{UE,RE}^{H}Z_{UE,RE}=I), V_{UE,RE} is r_{UE,RE}-by-N_{Rx} orthonormal matrix (s.t. V_{UE,RE}^{H}V_{UE,RE}=I), and S_{UE,RE} is r_{UE,RE}-by-r_{UE,RE} square diagonal matrix. The number of MIMO flows of H_{UE,RE} is r_{UE,RE}≤min(N_{Tx},N_{Rx}). When the transmitter applied a precoder matrix Z_{UE,RE}^{H} and correspondent receiver applied a receiving matrix V_{UE,RE}, the N_{Tx}-by-N_{Rx} MIMO channel would become:

$${{Z}_{UE , RE}}^{H} {H}_{UE , RE} {V}_{UE , RE} = ( {{Z}_{UE , RE}}^{H} {Z}_{UE , RE} ) {S}_{UE , RE} ( {{V}_{UE , RE}}^{H} {V}_{UE , RE} ) = {S}_{UE , RE}$$

With reduced-rank SVD, S_{UE,RE} is a r_{UE,RE}-by-r_{UE,RE} diagonal matrix.

Mathematically speaking, the precoder matrix Z_{UE,RE}^{H} at the transmitter and the receiving matrix V_{UE,RE} at the receiver synergy the entire MIMO channel on the effective sub-channels by linear transformations over the MIMO channel H_{UE,RE}. MIMO gain or space diversity gain, indicated by

$$SNRs \frac{{‖ {h}_{UE , RE} ( i ) ‖}^{2}}{N} ,$$

i=1, 2, . . . , r_{UE,RE}, is attributed to inherent space diversity of MIMO channel between transmitter and receiver, which is related to radio environment. Empirically, radio channels in such a complex environment as downtown area would have higher number of MIMO flows than in a simple rural environment, because high buildings in downtown yield more space diversity by more radio reflectivity.

For higher MIMO gain, wireless systems increases the number of antenna ports, that is, N_{Tx} and N_{Rx}, which hoists the upper-bound of the number of potential MIMO flows, because of r_{UE,RE}≤min(N_{Tx},N_{Rx}). But, in reality, r_{UE,RE} is far way smaller than its upper-bound, min (N_{Tx},N_{Rx}). This motivates the deployment of MU-MIMO: if one MIMO channel yields insufficient number of MIMO flows, several MIMO channels could be multiplexed by a common precoder W. Imagine that two MIMO channels, H_{UE(1),RE} and H_{UE(2),RE}, on the same RE, are very different from each other; then it is likely to find a common precoder to multiplex (separate) both; whereas imagine that two MIMO channels, H_{UE(1),RE} and H_{UE(2),RE}, on the same RE, are almost the same; then it is unlikely to find a common precoder to multiplex (separate) both.

Mathematically, this common precoder W is related to precoders Z_{UE(1),RE} and Z_{UE(2),RE}. A widely used method in practice is based on EZF. Concatenate two precoders from reduced-SVD on MIMO channels into one by [symbol] =[Z_{UE(1),RE} Z_{UE(2),RE}] where [symbol] is a N_{Tx}-by-(r_{UE(1),RE}+r_{UE(2),RE}) matrix. In EZF way, their common precoder is W= [symbol] where W is a N_{Tx}-by-(r_{UE(1),RE}+r_{UE(2),RE}) matrix. If Z_{UE(1),RE} and Z_{UE(2),RE} are orthogonal, [symbol] approaches an identity matrix, W= [symbol] =[Z_{UE(1),RE} Z_{UE(2),RE}], meaning that the transmitter can continue using precoder matrix Z_{UE(1),RE} for UE-1 and precoder matrix Z_{UE(2),RE} for UE-2 to multiplex on this RE on the same time without MAI. If Z_{UE(1),RE} and Z_{UE(2),RE} are the same, [symbol] approaches a singular matrix (irreversible) so that no common precoder W is available. These two UEs cannot be paired together. In practice, most cases are between the two extremities. [symbol] is neither an identity matrix nor a singular matrix. Transmitter has to compute the common precoders for all the possible combinations and then find the best one. Unfortunately, it is a NP-hard problem. Suppose that a transmitter has 200 candidate receivers. In theory, this transmitter has to make an exhaustive search among

$${\sum }_{i = 2}^{200} ( \begin{matrix}i \\ 200\end{matrix} )$$

times different common precoder W computation for different combinations of receivers. Besides, in order to increase the extent to which [symbol] approaches an identity matrix and pair or group more receivers, we usually makes N_{Tx}>>Σᵢr_{UE(i),RE}, motivating wireless systems to adopt more antenna ports or more precisely higher MIMO antenna port ratio between transmitter and receiver (N_{Tx}/N_{Rx}).

After the common precoder W is computed, the transmitter would multiply it to its transmitted signals.

### MU-MIMO Engineering Tradeoffs

For a wireless system, MU-MIMO is usually used in DL, where BS is transmitter and UEs are receivers. MIMO channels of multiple UEs are paired by a common precoder W to multiplex on the same REs (frequency) and the same time durations (timing).

For higher throughput and system efficiency, modern MU-MIMO system deploys lots of antenna ports across a wider band. For example, in a T-MIMO system (of 6G), it is expected that BS has 1024 antenna ports and UE has 32 antenna ports over 500 MHz bandwidth. MIMO channel becomes a three-dimensional tensor (N_{RE}-by-N_{Tx}-by-N_{Rx}).

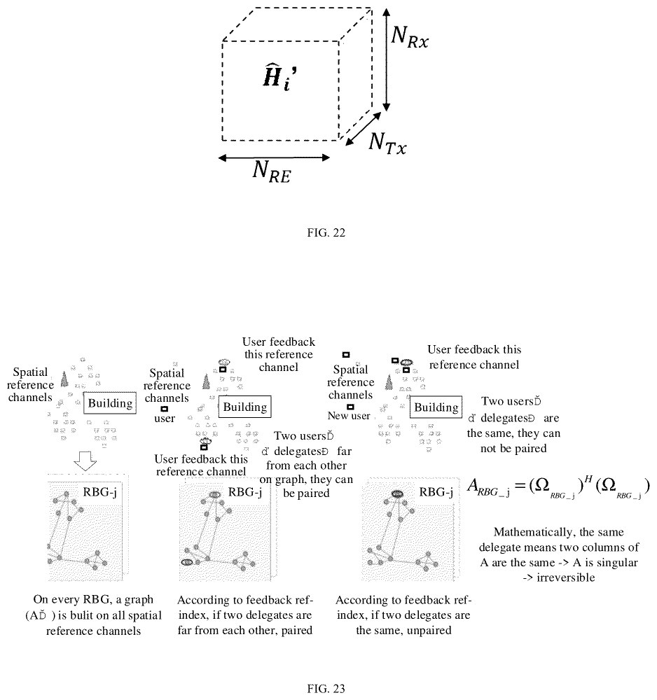

### FIG. 22: Dimensionality of a TMIMO Channel

### Major Tradeoff #1: Assumption on DL/UL Channel Reciprocity

Although MU-MIMO should be paired over the DL channels between one BS and multiple UEs, it is impracticable for each candidate UE to report or feedback its DL channel estimation to the BS, because it would result into a huge UL feedback overhead due to the large dimensionality of T-MIMO channel. In TDD system, it is assumed that the DL channel between one BS and one UE can be approximated by the UL channel between the BS and the UE. In 4G and 5G-NR systems, SRS UL channel is specified for the UL channel measurement or estimation for this purpose. SRS UL channel is shared by a number of UEs. These UEs send their own SRS reference signals on the SRS pilot positions so that the BS can estimate their UL MIMO channels respectively. In 5G-NR, the sharing is achieved by coding multiplexing on modulation signals.

### Major Tradeoff-2: Random or Quasi-Random MU-Pairing Implementation

As aforementioned, MU-Pairing is a NP-hard problem. In theory, the optimal pairing is a result from an exhaustive search (computation) on all the possible combinations of the candidate UEs, from 2 of them up to all of them. However, the computation involving a pseudo-inversion of large matrix z is too long for a real-time signal processing during one TTI or several TTIs. In particular, when N_{Tx} is more than hundreds or even thousands and pairing 10 or 20 UEs in several TTIs, the pseudo-inversion of matrix [symbol] could become computation-wisely forbidden for most hardware implementation. Due to the complexity, storage and latency limitations, it is forbidden to exhaustively search the best pairing scheme in a practical implementation. Instead, some random or quasi-random selection of a fixed number of the paired UEs from a big pool of candidates is firstly conducted into z and then followed by a common precoder matrix EZF computation W= [symbol] . Empirically, the selection may consider the positions of the candidate UEs. For example, an empirical selection algorithm may tend to choose the paired UEs far from each other, because it is more likely for these UEs to have orthogonal MIMO channels. For example, the number of the paired is simply given by empirical experience, system, or hardware limitations.

Strictly speaking, the tradeoff doesn't realize the pairing but only compute the precoder matrix W from whichever reversible [symbol] .

### 5G-NR SRS UL and CSI-RS to Acquire DL MIMO Channels

5G-NR employs SRS UL channel to measure UL MIMO channels between BS (as transmitter) and multiple UEs (as receivers). BS would assume its measured or estimated UL MIMO channels from its SRS UL channel(s) as its DL MIMO channels between the BS and the UEs in TDD mode.

In details, SRS UL channel defines a set of uniform pilot (or reference signal) placement or position patterns in terms of RE (frequency), BS antenna ports, and UE antenna ports. The uniform pilot placement patterns are specified in the 5G-NR standards that both BS and UEs must comply with. One of the reasons to standardize uniform pilot placement patterns is its simplicity, that is, only a few of the parameters exchange both transmitter and receiver to align each other of the current pattern(s) to be used.

Moreover, in order for BS to measure more than one UE simultaneously, a coded multiplexing scheme is used over the pilots allowing more than one UEs to mask their pilots with different codes to share the same pilot positions. In 5G-NR, the coded multiplexing scheme on SRS UL channel is designed to accommodate up to 16 UEs. If there are more than 16 UEs requiring to share the SRS UL channel, new pilot positions have to be consumed. As a result, 5G-NR has a capacity for a SRS UL channel to measure a number of UEs simultaneously.

UL/DL channel is not always reciprocal, if RF and IF part are considered. For example, BS's RF component is designed for much higher Tx power than UE's RF one, resulting into DL coverage bigger than UL one.

The received UL signal strength from the UEs on the edge of a cell to the BS may be too weak to be estimated. These UEs have to feedback their DL MIMO channels rather than sending their pilots on SRS UL channel. Accordingly, 5G-NR provides them with CSI-RS, uniform pilot placement patterns, in DL channel(s). A UE would estimate the channel coefficients on the pilots (RS, reference signals) in the DL channels and then interpolate the entire channel coefficient from the estimated ones. The UE compresses the entire channel estimation into CSI and then feedbacks it to the BS in UL channel. 5G-standard defines not only the pilot placement pattern(s) for CSI-RS in DL channel but also the compression method. For example, CSI includes PMI and RI, both of which are the index in some pre-configured tables of precoding matrix and ranks. It is expected that the BS would decompress CSI into the DL MIMO channel estimation and then conduce the ensuing MU-MIMO pairing and common precoder computations. In general, CSI-RS DL channel result into CSI compression for a purpose of reconstruction; in specific, CSI compression or encoder specified in 5G-NR is a lossy compression.

### MU-MIMO Pairing and Precoding Matrix Computation by EZE

As described in the background section, the pairing search and common precoder matrix computation are done together.

Firstly, the computation of the common precoding matrix cannot be done until all the SVDs on the candidate UEs are done. [symbol] =[Z_{UE(1),RE} Z_{UE(2),RE} . . . ]. Especially in T-MIMO, for each candidate UE, BS needs to estimate their MIMO channel H_{UE,RE} either from SRS UL channel or from CSI feedback, and then calculate rank-reduced SVD on a large number of N_{Tx}-by-N_{Rx} matrix.

Secondly, a pseudo-inversion operation of [symbol] would be too complicated to be finished in several mille-second duration. For example, in T-MIMO, z is a thousand-by-hundred complex matrix. Within one TTI (2 ms), it is nearly impossible to calculate [symbol] over a large number of candidate [symbol] .

### Non-Uniform Pilot Placement Patterns

Both 5G-NR SRS UL Channels and CSI-RS DL channels employs uniform pilot placement patterns, partly because uniform pilot placement patterns are among the safest method to ensure channel estimation performance in particular with little prior-knowledge about the current channel, partly because they are easy to be described, standardized, and aligned (configured) across transceiver. However, uniform pilot placement patterns are one of the lowest efficient patterns. Its density must be designed for the worst case in statistics, which is rare in practice. In another word, uniform pilot placement patterns specified in the 5G-NR standard may as well be over-designed in most practical cases.

In 5G-NR, average density of its uniform pilot placement patterns is about 7%-17% of its radio resource to be used for pilots or reference signals. For example, one reference signal placed every RB (made of 12 consecutive REs) results into 8.33% (˜ 1/12) pilot overhead. As shown in FIG. 22, if TMIMO employed the same uniform density of 5G-NR, pilot overhead would be too heavy to be processed, or at least, forbid the UEs on the edge of a cell to feedback their T-MIMO CSI.

In theory, non-uniform pilot placement patterns based on prior-knowledge about distribution of a channel would consume much less pilot overhead. First of all, how is prior-knowledge learned and represented? In [2], it is invented that the prior-knowledge about a high-dimensional signal space (MIMO channel can be considered as high-dimensional signal space) is represented by an orthonormal basis N_{dim}-by-rₑₙᵥ U (s.t. U^{H}U=I). One column of U is one of the basis, meaning that any two columns of U are perfectly orthogonal to each other. In the IPR, we use the column as basis; it can be easily applied to that basis matrix whose rows are basis; simply U^{H}. N_{dim} is the total dimension after a signal space tensor is vectorized. For example, the total dimension of a MIMO channel of N_{RE}-by-N_{Tx}-by-N_{Rx} is N_{dim}=N_{RE}N_{Tx}N_{Rx}·rₑₙᵥ is related to how complicated the prior-knowledge contain. In mathematics, rₑₙᵥ is the number of principal components of the prior knowledge.

[2] proposes to use data-learning method to learn the prior knowledge. The basis U is computed from a number of data samples collected or sampled in the area. [1] further proposes to apply this data-learning method in MIMO case where U is a representation of a common spatial prior-knowledge of MIMO channels within an area of interest.

From the prior knowledge represented a common spatial basis (U), a near-optimal non-uniform pilot placement pattern can be computed by pivot QRD [3] on U: UP=QR. The several “strongest” pivots in P (in typical pivot QRD, the pivots are ordered in terms of their importance or contributiveness) would indicate the most important or contributive positions to place reference signals (or pilots) for the reconstruction purpose.

As shown in [1] and [2], non-uniform pilot placement pattern(s) indicated by pivots in P would result into near minimum pilot overhead but still minimize MSE [6] on the reconstruction (or decoder, decompression).

### 3.2.1 Technical Solution in the Prior Art

Prior-of-Art: SRS-sounding UL channel
Prior-of-Art: CSI-RS DL channel
Prior-of-Art: EZF-based MU-MIMO Pairing and Precoder matrix computation
Prior-of-Art: QRD-based non-uniform pilot placement and compression

### 3.2.2 Disadvantages of the Prior Art

### 5G-NR SRS UL and CSI-RS to Acquire DL MIMO Channels

The first major disadvantage is due to the assumption about UL/DL channel reciprocity. Although the over-the-air part of a MIMO channel can typically meet UL/DL reciprocity thanks to information theory (I(X,Y)=I(Y,X),I(X,Y) is the mutual information of two random variable X and Y), the RF and IF components (analogy circuits) do not generally hold UL/DL reciprocity assumption. Thereby, the assumption would inevitably damage the overall performance. In addition, the assumption holds only in TDD mode but not in FDD mode.

The second major disadvantage appears when the dimensions of MIMO channel go to such a great number as T-MIMO in FIG. 22. BS has to estimate the entire MIMO channels for all the coded multiplexed UEs on its SRS UL channels. Firstly, it must estimate the channel coefficients on every single pilot for each coded multiplexed UE. Secondly, it must interpolate the entire MIMO channel from the estimated channel coefficients on the pilots for each UE. Thirdly, it must try to pair all the active UEs and compute their common precoder. The dimensions of a typical T-MIMO make storage and computation forbidden.

The third major disadvantage is due to MAI among coded multiplexed UEs sharing on the same SRS UL channel. MAI is inevitable. On one hand, it would limit the maximum number of the coded multiplexed UEs (capped capacity); on other hand, it would damage the accuracy (or performance) on the channel estimation. This is why 5G-NR has to limit the maximum number of UEs to share the same SRS UL channel. Nevertheless, the capped capacity on the SRS UL channel would present scheduling and overhead in 6G where much more active UEs would be accommodated by one BS than 5G-NR.

The fourth major disadvantage is due to the mobility. It is well-known that radio channel would change significantly when a UE is moving. Sometimes, even a small position displacement would cause a LOS loss, leading to a tremendous channel change. As SRS UL channel is shared among all active UEs and SRS UL channel has capacity cap, it is uneasy and power-consuming for a bunch of UEs and a BS to perform their SRS-UL channel estimations so frequently. Therefore, in practice, SRS-UL-based MU-MIMO is much sensitive to mobility.

The last major disadvantage is to involve DL CSI-RS channels for the UEs on the edge of the cell. In fact, UEs on the edge of a cell that uses CSI-RS would suffer from more severe performance loss.

### MU-MIMO Pairing and Precoding Matrix Computation by EZF

The first disadvantage is due to the fact that [symbol] =[Z_{UE(1),RE} Z_{UE(2),RE} . . . ] must be calculated for any potential pairing trial. If a candidate UE is NOT paired (only one gets selected, the rest are not paired), the radio overhead (SRS UL channel or CSI-RS channel, and CSI feedback) and computation overhead (channel estimation, SVD, decompression) are wasted.

The secondly disadvantage is due to the fact that a pseudo-inversion operation [5] of [symbol] must be calculated for any potential pairing trial, which is widely used EZF method. If a candidate paring z is not selected (only one gets selected, the rest are not paired), computation and storage overhead [symbol] are wasted.

The final disadvantage is that the pairing and precoder computation is sequential: [symbol] must be estimated and calculated before pairing [symbol] is tried.

### QRD-Based Non-Uniform Pilot Placement and Compression

Although this method provides good channel estimation and compression scheme with near minimum pilot overhead and compression overhead, this is still for the purpose for a reconstruction of channel as reliably as possible. This purpose entails its minimum overheads in number of the reference signals and in compression ratio, both of which require in depth minimum size of a common spatial basis (U). From source coding point of view, common spatial basis (U) is code book to minimize MSE in the reconstruction. How many rₑₙᵥ of N_{dim}-by-rₑₙᵥ U are kept determines how much “details” to be reconstructed. As common spatial basis (U) is resultant of SVD [4] and SVD usually orders the columns of U in descendent of their corresponding singular values, the first column of U would be more important (more principal in mathematic term) than the second one and so on so forth. More columns kept in U would offer more “details” on the reconstruction but the “details” are less important from energy point of view.

In order to reconstruct the entire MIMO channel (H_{UE,RE}) and non-uniform pilot patterns (P), a big enough common spatial basis (U) should be aligned between BS and UEs. Unfortunately, in TMIMO scenario, both U and P are in a huge amount. Further, when a UE moves from one area to another, it must be updated from the current U and P and new U and P.

Since common spatial basis (U) is learned from a number of data samples, common spatial basis (U) is itself a highly-IPR entity. It is costly to collect and clean data samples and compute common spatial basis (U), especially data samples in a great dimension. Whoever with common spatial basis (U) can optimize its non-uniform pilot patterns and even compression schemes.

### Detailed Descriptions of the Technical Solutions of the Present Invention

This invention focuses on how to achieve MU-MIMO pairing and precoder matrix computation in T-MIMO scenario. Generally speaking, the invention would involve how to estimate DL MIMO channel for moving UEs, how to select the best pairs or groups (more than two UEs) among all candidate combinations, how to calculate a common precoder matrix in a reasonable storage and computation complexity.

As illustrated in FIG. 22, the critical issues comes from T-MIMO's huge dimension, which presents the challenges on every steps for feedback, storage, and calculations.

In more details, the following major problems are to be solved by the invention:

(1) The method in the invention makes no more assumption of UL/DL channel reciprocity; thus, there's no performance lose and no discrimination against the UEs on the edge of a cell; moreover, since CSI-RS DL channel can be naturally shared among infinite number of UEs simultaneously; finally, it could support FDD-MU-MIMO.

(2) UE would estimate a DL MIMO channel by a CSI-RS DL channel with a super-sparse non-uniform pilot placement pattern rather than 5G-NR CSI-RS DL channels with a uniform pilot placement pattern; the non-uniform pilot placement pattern of the invention requires several-order lower pilot density than 5G-NR's uniform one.

(3) UE could feedback a highly compressed CSI to BS, consuming several-order less than 5G-NR's CSI compression;

(4) BS wouldn't decompress CSI but keep using the compressed CSI to complete all the following operations including SVD-based MIMO channel decomposition, EZF-based pairing and precoder matrix computation; thus, much storage and computation complexity could be saved.

(5) Pairing and precoder matrix computation can be decoupled; further, pairing or grouping would take place before SVD channel decomposition is conducted; it means that only selected UEs would be informed to feedback its compressed CSIs to BS for the final common precoder matrix computation; parallelism is achieved between pairing trials and precoder computation.

(6) Pairing can be simplified to support high mobility.

To solve the challenges and problems in the previous section, we mainly rely on the two fundamentals: environment-dependent MIMO channels and equivalent low-dimensional signal space.

It is well known that a radio channel between a transmitter and receiver is mainly dominated by its environment. Inherent relevance between environment and radio channel is embodied in RT channel models that generate channel responses in function of LOS and NLOS (reflections and/or diffusions), that is, rays or a cluster of rays, plus some randomness. According to RT channel model, a radio channel consists of a determinist part due to RT and a stochastic part due to random events. The determinist part is some common characteristics among channels within nearby area, which could be learned and represented into a common orthonormal basis (U), called basis in the following discussion. Any channel h (vectorized) can be represented by a weighted linear combination of the columns of basis U, where the weight coefficients are called as spectrum coefficients vector c: h=Uc. Although common orthonormal basis (U) is a thin and tall matrix (N_{dim}>>rₑₙᵥ), spectrum coefficients vector c (rₑₙᵥ-by-1), much smaller than h (N_{dim}-by-1), is mathematically an equivalent low-dimensional space of h. It allows that some storages, representations, or calculations on h can be equivalently performed on c, an equivalent low-dimensional signal space of h.

In this IPR disclosure, DL pilot placement pattern, channel estimation, spatial reference channels,

In the following discussions, we will use T-MIMO radio channel as an example because of its great dimensionality as illustrated in FIG. 22, and we will abbreviate it into radio channels or channels. Remember that spatial reference (mooring) channels can be applied to great-dimensional signal space other than T-MIMO.

1: Common Prior-Knowledge about Radio Channels

A radio channel, i.e. multiple-path fading channel, is more or less affected by its surroundings, because its radio paths, rays, or clusters (or groups) of its rays, are physically related to reflections and diffusions on physical surfaces, edges, or corners of buildings, roads, buses, tracks, persons, and so on. Some surfaces, edges, and corners are immobile (e.g. buildings, bridges, poles, roads, pavements etc.); some are moving (e.g. moving vehicles and pedestrians etc.). In general, immobile factors contributes to some deterministic part of a radio channel, whereas moving ones to stochastic part.

Up to 5G-NR, wireless systems have considered both deterministic and stochastic parts together as one radio channel entity, and have assumed no prior-knowledge about radio channels so that they must consume both pilot and measurement feedback overheads for transceivers to synchronously know what current channel is.

Since most immobile factors to which the deterministic part of a radio channel is attributed can usually be prior known or available, this portion of a radio channel could be also prior known for both transmitter and receiver, leaving only the stochastic portion for pilot and measurement feedback overheads, and overwhelmingly increasing effective bandwidth efficiency. In most practical cases that deterministic portion of a radio channel persistently and consistently dominate the radio channel more than the stochastic one, it is worthwhile and crucial to acquire the prior-knowledge about the radio channel, which could be represented in the following various forms:
Alternative #1: a statistic function or functions with arguments;
Alternative #2: one or several orthonormal basis;
Alternative #3: one or several DNNs;
and so on

Although a prior-knowledge of a specific radio channel between one transmitter and receiver can be learned or acquired, it is more useful to learn or acquire a common prior-knowledge covering a number of similar radio channels within a specific spatial area in the context of cellular communications. By doing that, an acquired prior-knowledge will be shared and reused among any new radio channel within that spatial area. In this sense, the acquired prior-knowledge represents a spatial commonality closely related to that spatial area. A BS, as either transmitter or receiver, can possess one or several common prior-knowledges related to one or several overlapping or non-overlapping spatial areas. Moreover, as different bands correspond to different wavelengths, a BS may have one prior-knowledge representation for one band and another for another band.
Alternative #1: a BS has one common prior-knowledge;
Alternative #2: a BS has several sectors, each of which has its own common prior-knowledge; these sectors can be overlapped or non-overlapped;
Alternative #3: a BS has one common prior-knowledge but has several sectors, each of which has its own common prior-knowledge; these sectors can be overlapped or non-overlapped;
Alternative #4: a BS has several pre-installed Tx precoders, each of which has its own common prior-knowledge;
Alternative #5: a BS can have one prior-knowledge specific for one of its associated UE; it may be useful for some fixed UEs;
and so on;
   2: Preparing Data Samples to Learn or Acquire Common Prior-Knowledge about Radio Channels

Common spatial prior-knowledge related to a given spatial area proposed in the 1 is acquired or learned on data samples that are prepared in the following various ways:

Alternative #1: a common prior-knowledge is acquired or learned from the data sample set, learning data set, or training-data set that have been accumulated by either transmitter or receiver in the history.; at all beginning, BS, as transmitter, without prior knowledge has to make use of some prior-of-art methods such as SRS sounding and/or CSI-RS to accumulate a sufficient amount of radio channel data samples, from which the common prior-knowledge is learned.

Alternative #2: a common prior-knowledge is acquired or learned from the data sample set, learning data set, or training-data set feedback by some reference units (reference UEs or sensing UEs), as receivers, deployed in the area and feedbacking their DL estimated radio channels to the BS, as transmitter, to accumulate a sufficient amount of radio channel data samples, from which the common prior-knowledge is learned.

Alternative #3: a common prior-knowledge is acquired or learned from the sample-data set, learning data set, or training-data set that is virtually generated by digital twin; digital twin generates virtual data samples in function of 3D map/model or other environment-related information.

Alternative #4: a common prior-knowledge is acquired or learned from the sample-data set, learning data set, or training-data set that is a combination results from alternative #2 and alternative #3; at all the beginning, digital twin generates the initial data sample set for an initial prior knowledge; then the initial prior knowledge triggers first real measurements and feedbacks on deployed sensing UEs; and then first measurements partially replaces some samples in the data sample set into a second data sample set for a refined second-time prior knowledge; refined prior-knowledge triggers second real measurements and so on.

Alternative #5: a common prior-knowledge is acquired or learned from the sample-data set, learning data set, or training-data set that is a combination results from alternative #1, alternative #2 and alternative #3; at all the beginning, historic data and digital twin generates the initial data sample set for an initial prior knowledge; then the initial prior knowledge triggers first real measurements and feedbacks on deployed sensing UEs; and then first measurements partially replaces some samples in the data sample set into a second data sample set for a refined second-time prior knowledge; refined prior-knowledge triggers second real measurements and so on.

### 3: Representing and Learning/Acquiring Common Prior-Knowledge Based on Orthonormal Basis (Unitary Matrix)

Common spatial prior-knowledge related to a given spatial area proposed in the 1 can be represented in the different forms: statistic-based, basis (unitary matrix)-based, and DNN-based. In fact, prior-of-art wireless systems has used statistic functions or formulas to compute key statistic values about a radio channel, e.g. coherent time, coherent frequency, RMS delay and so on. Basis-based and DNN-based representations are acquired from the data samples prepared in 2. In general, basis-based representation is linear; while DNN-based is a non-linear approximation to basis-based one. This embodiment focuses on how to learn or acquire a basis-based representation of a common prior-knowledge of radio channels related to a specific spatial area.

A MIMO radio channel is a three-dimension tensor: N_{RE}-by-N_{Tx}-by-N_{Rx} [symbol] . It must be vectorized for matrix-based decomposition.

If all MIMO radio channel samples are vectorized in the same dimension order, the order itself doesn't matter for the ensuing learning performance too much. In this IPR, first MIMO radio channel data sample in tensor is N_{RE}-by-N_{Tx}-by-N_{Rx} [symbol] and is vectorized in RE->Tx->Rx order into a h₁ (N_{dim}-by-1, N_{dim}=N_{RE}N_{Tx}N_{Rx}), first column vector; second MIMO radio channel data sample in tensor is N_{RE}-by-N_{Tx}-by-N_{Rx} and is vectorized in the same order into a h₂ (N_{dim}-by-1, N_{dim}=N_{RE}N_{Tx}N_{Rx}), second column vector; and so on until all M MIMO radio channel samples in tensor are vectorized.

A sufficient number (M s.t. N_{dim}>M>rₑₙᵥ) of the vectorized MIMO radio channel samples are placed into a N_{dim}-by-M matrix: [symbol] =[h₁ h₂ . . . ] (the order of data samples doesn't matter). Learning is conducted by a rank-reduced SVD: [symbol] =UΣV^{H}, where U is N_{dim}-by-rₑₙᵥ unitary (orthonormal) matrix and represents a common (spatial) prior-knowledge of all the M data samples related to a specific spatial area.

(Note that in the deduction above we set h as column vector. Without loss generality, if h is set as row vector, ->

$$𝕙 = [ \begin{matrix}{h}_{1} \\ {h}_{2} \\ ⋮\end{matrix} ] -> 𝕙 = U {ΣV}^{H} -> V$$

represents a common (spatial) prior-knowledge. Mathematically both are exactly the same. In the following discussion, we will use the column vector version.)

With the basis (U), each vectorized channel data sample h can be projected (compressed or encoded) into an equivalent low-dimensional space named as spectrum coefficient representation: c=U^{H}h, where c is rₑₙᵥ-by-1 vector. c contains all the principal information of h, because spectrum coefficient representation can be projected back (decompressed or decoded) to original channel data space: h=Uc.

### 4: Representing and Learning/Acquiring Common Prior-Knowledge Based on DNN

DNN-based representation of a prior knowledge in the 2 is an approximation to linear basis (U) in the 2. The encoding DNN (c=ƒ(h;α)) approximates c=U^{H}h of 3; whereas the decoding DNN (h=g(c;β)) approximates h=Uc of 3. The output of the latent layer (c=∂(h;α)) approaches to equivalent low-dimensional space, i.e. spectrum coefficient representation of 3.

To approach a rank-reduced SVD [symbol] =UΣV^{H} (of 3) that minimizes MSE ∥ [symbol] −UΣV^{H}∥², DNN-based representation may set its training or learning goal to minimize MSE ∥h₁−g(ƒ(h₁;α);β)∥² for all the M training data samples (h₁, h₂, . . . , h_{M}) by tuning the neurons α and β in a SGD way.

### 5: Scoring Distance Between any Two Radio Channels

Per mathematical property of SVD, basis U of 3 represents a common (spatial) prior-knowledge of all the radio channels related to a specific spatial area. Any new MIMO radio channel (hᵤₛₑᵣ) (N_{dim}-by-1, N_{dim}=N_{RE}N_{Tx}N_{Rx}) can be safely projected into a low-dimensional space, that is, spectrum coefficient vector (cᵤₛₑᵣ) (rₑₙᵥ-by-1) by the basis (U) s.t. hᵤₛₑᵣ=Ucᵤₛₑᵣ and cᵤₛₑᵣ=U^{H}hᵤₛₑᵣ.

Basis U allows to score or measure “distance (similarity, correlation etc)” metric between any two radio channels (hᵤₛₑᵣ₁ and hᵤₛₑᵣ₂) in the equivalent low-dimensional space. Denote a scoring or measuring function δ_{1,2}=d(hᵤₛₑᵣ₁,hᵤₛₑᵣ₂) that returns the “distance”, “similarity”, or “correlation” between two radio channels (hᵤₛₑᵣ₁ and hᵤₛₑᵣ₂). If d( ) is linear, then δ_{1,2}=d(hᵤₛₑᵣ₁,hᵤₛₑᵣ₂)=d(Ucᵤₛₑᵣ₁,Ucᵤₛₑᵣ₂)=Ud(cᵤₛₑᵣ₁,cᵤₛₑᵣ₂), meaning that the scoring or measuring can be equivalently taken on the low-dimensional spectrum space. The scoring or measuring function d( ) can be linear and simple:
Alternative #1: Euclidean function
Alternative #2: inner product
and so on

In case of DNN-based representation in 4, scoring or measuring functions on the latent layer output would be another DNN (δ_{1,2}=d(cᵤₛₑᵣ₁,cᵤₛₑᵣ₂,γ)), where y are neurons.

### 6: Generating and Aligning Pilot Placement Patterns and Feedback Spectrum Coefficients

Basis U of 3 represents a common (spatial) prior-knowledge of all the radio channels related to a specific spatial area. Any new MIMO radio channel estimation (ĥᵤₛₑᵣ) (N_{dim}-by-1 N_{dim}=N_{RE}N_{Tx}N_{Rx}) can be projected (compressed) into a low-dimensional spectrum coefficient vector (ĉᵤₛₑᵣ) (rₑₙᵥ-by-1) s.t. ĥᵤₛₑᵣ=Uĉᵤₛₑᵣ and ĉᵤₛₑᵣ=U^{H}ĥᵤₛₑᵣ. In the IPR, estimated value is with “hat”.

### Pilots for Channel Estimation

For the purpose of channel estimation ĥᵤₛₑᵣ against the stochastic part of a radio channel in 1, pilot placement or position patterns or schemes should be clearly specified and aligned across both transmitter and receiver.
Alternative #1: by legacy uniform pilot placement patterns; e.g. every RB has 1 pilot and pilots are constantly placed cross the RB direction in 5G-NR specification; both transmitter and receiver are specified by following the 3GPP standards.
Alternative #2: by pseudo random pilot placement pattern in which the pilot positions are generated by a function of random seed(s); pattern-functions and random seed(s) must be explicitly or implicitly aligned across transmitter and receiver;
Alternative #3: by pilot placement patterns in a function of basis U; one exemplary method that approaches an optimal pattern is disclosed in [1] (with augmented version because of MIMO) and [2] (without augmented version); either generative function and basis U are explicitly or implicitly aligned across transmitter and receiver, or generated patterns are explicitly or implicitly aligned across transmitter and receiver.
Alternative #4: by pilot placement patterns output from generative DNN; either generative DNN and its input are explicitly or implicitly aligned across transmitter and receiver, or generated patterns are explicitly or implicitly aligned across transmitter and receiver
so on

In whichever generation method, pilot placement pattern can be represented by a Nₚᵢₗₒₜ-by-N_{dim} sampling (position or placement) matrix P, each row of which has only one “1” to indicate the position to be used as pilot; BS, as transmitter, transmits pilots on these positions indicted by the sampling matrix P; UE(s), as receiver(s), estimate the channel coefficients (ĥₚᵢₗₒₜ_{ᵤₛₑᵣ}) on these positions indicated by the same sampling matrix P. In most practice cases of non-uniform placement scheme, sampling matrix P can be so sparse i.e. Nₚᵢₗₒₜ<<N_{dim}, that system consume small pilot overhead.

Accordingly, to align the pilot placement scheme across transmitter and receiver, system can:
Alternative #1: By pre-defined standard protocol, similar to 5G-NR;
Alternative #2: by a random seed and standardized method or generative function of random seed;
Alternative #3: by generative function from the basis U, if U is available for both sides.
Alternative #4: by generative DNN and its inputs;
Alternative #4: by directly sending the pilot placement matrix (or scheme) as payload

### Feedbacks of Channel Estimation

More interestingly, sampling matrix P can be used to “compress” basis U (N_{dim}-by-rₑₙᵥ) into a Nₚᵢₗₒₜ-by-rₑₙᵥ θ as θ=PU. Because θ is much smaller than U (because Nₚᵢₗₒₜ<<N_{dim}) and no one can reconstruct basis U from θ, θ can be a better alternative to U. Furthermore, receiver can directly obtain spectrum coefficient vector: ĉᵤₛₑᵣ=U^{H}ĥᵤₛₑᵣ=θ(θ^{H}θ)⁻¹ĥₚᵢₗₒₜ_{ᵤₛₑᵣ} by θ; receiver doesn't need to interpolate from ĥₚᵢₗₒₜ_{ᵤₛₑᵣ} to ĥᵤₛₑᵣ; θ(θ^{H}θ)⁻¹ is an even better alternative to θ. Therefore, there are several alternative ways for both transmitter and receiver to align on their prior-knowledge:
Alternative #1: either transmitter or receiver transmits the basis U to the other;
Alternative #2: either transmitter or receiver transmits the basis θ to the other;
Alternative #3: either transmitter or receiver transmits the basis θ(θ^{H}θ)⁻¹ to the other;

If the basis is approached by DNN, both transmitter and receiver should be aligned with ƒ(;α) and g(;β) of the 4.

To minimize pilot and feedback overheads, both transmitter and receiver had better to be aligned by a random-seed, a pseudo-random generative pilot placement function and θ(θ^{H}θ)⁻¹. In T-MIMO scenario, BS, as transmitter, would broadcast or multicast a common pilot placement scheme by a random seed and θ(θ^{H}θ)⁻¹ in DL as controlling payload, and transmits the pilots according to the common pilot placement scheme. Candidate UEs, as receivers, will obtain the common pilot placement scheme and θ(θ^{H}θ)⁻¹; demodulates the pilots according to the pilot placement scheme, estimates the channel coefficients on the pilots, and compute the spectrum coefficients in terms of the channel estimation on the pilots. Optionally, the UE could feedback the spectrum coefficients to the BS in UL as controlling payload immediately after obtaining the spectrum coefficients.

### 7: Selecting (Spatial) Reference (Mooring) Channels

A set of K (K≤M) radio channels are selected from the M training data samples, [symbol] =[h₁ h₂ . . . h_{M}] of 2 and 3 as spatial reference (or mooring) channels. The set is dynamic and adaptive: keeping updated over the time: old reference channels get retired and new ones get selected. Its size (K) can be either fixed or varying over the time. The set may include several either overlapping or non-overlapping subsets. The selection method can be:
Alternative #1: a random selection by a given K;
Alternative #2: selection based on K-means, GMM, and the other classification algorithms.
Alternative #3: selection based on Graph on the “distance” among the data samples as mentioned in the 5; for example, select the “hub” nodes on the graph with the most degrees.

FIG. 23: Hubs in Graph are most representative nodes

In whichever selection method, K radio channel samples are selected into a set of spatial reference (mooring) channels: [symbol] =[h_{Set(1)} h_{Set(2)} . . . h_{Set(K)}], where Set(k) returns the index of the selected data sample in the [symbol] of 2.

In the following discussions, we will focus on single set of spatial reference channels unless it is explicitly claimed, because single set can be easily extended to multiple sets.

### 8: Compressing Spatial Reference Channels and Sending to UEs

Compressing Reference Channel

[symbol]

BS, as transmitter, is supposed to transmit a portion or complete set of spatial reference channels ( [symbol] =[h_{Set(1)} h_{Set(2)} . . . h_{Set(K)}]) selected in the 7 to UEs, as receivers. However, in T-MIMO scenario, dimension (N_{dim}) of reference channels is too big to be transmitted in DL.

According to 3, a radio channel can be equivalently projected (compressed or encoded) into a spectrum coefficient vector: c_{Set(k)}=U^{H}h_{Set(k)}, k=1, 2, . . . , K. This projection compresses a set of spatial reference channels ( [symbol] =[h_{Set(1)} h_{Set(2)} . . . h_{Set(K)}]) in 7 into [symbol] =[c_{Set(1)} c_{Set(2)} . . . c_{Set(K)}], where c_{Set(k)} is a rₑₙᵥ-by-1 vector. If there are several sets or subsets of spatial reference channels mentioned in the 7, all the sets or subsets use the same basis U of 3 to compress their own spatial reference channels.

Preferably, BS, as transmitter, transmits a complete set or a partial set of compressed spatial reference channels [symbol] to its UEs, as receivers, in broadcast, multicast, or even unicast way via DL. Optionally and preferably, when BS, as transmitter, transmits each compressed spatial reference channel c_{Set(k)}, k=1, 2, . . . , K, it can transmit the first r′ₑₙᵥ (r′ₑₙᵥ<rₑₙᵥ) elements of c_{Set(k)} instead of all the rₑₙᵥ elements of c_{Set(k)}, saving a lot of DL payload by sending [symbol] =[c′_{Set(1)} c′_{Set(2)} . . . c′_{Set(K)}] and an indicator of r′ₑₙᵥ.

### Compressing Basis U

N_{dim} (dimension of both h_{Set(k)} and U) of TMIMO is too big for a BS or UE to store all the [symbol] and basis U. System need further compress them.

MU-MIMO pairing is conducted over RBG basis, in which one MU-MIMO pairing scheme and its precoder matrix are found on the average N_{Tx}-by-N_{Rx} MIMO channel over a RBG that includes several consecutive RBs (each RB has 12 REs). Firstly, h_{Set(k)} is reordered into its tensor form: N_{RE}-by-N_{Tx}-by-N_{Rx} [symbol] by the dimension order of 3: [symbol] =tensorize (h_{Set(k)}). From the 1^{st} RE to the N_{RE}-th RE, each RE has a N_{Tx}-by-N_{Rx} H_{Set(k),RE}(= [symbol] [RE,:,:]) MIMO channel. If the first N_{RBG} REs make the first RBG, N_{Tx}-by-N_{Rx} MIMO channel on the first RBG is average on the first N_{RBG} H_{Set(k),RE}, RE=1, 2, . . . , N_{RBG}:

$${H}_{Set ( k ) , RBG 1} = \frac{{\sum }_{RE = 1}^{RE = {N}_{RBG}} {H}_{Set ( k ) , RE}}{{N}_{RBG}} = \frac{{\sum }_{RE = 1}^{RE = {N}_{RBG}} tensorize ( {h}_{Set ( k )} ) [ RE , : , : ]}{{N}_{RBG}} ;$$

then N_{Tx}-by-N_{Rx} MIMO channel on the second RBG is

$${H}_{Set ( k ) , RBG 2} = \frac{{\sum }_{RE = {N}_{RBG + 1}}^{RE = 2 {N}_{RBG}} {H}_{Set ( k ) , RE}}{{N}_{RBG}} = \frac{{\sum }_{RE = {N}_{RBG + 1}}^{RE = 2 {N}_{RBG}} tensorize ( {h}_{Set ( k )} ) [ RE , : , : ]}{{N}_{RBG}} ;$$

and so on.

Since h_{Set(k)} can be represented as linear combination of the columns of the basis U by the spectrum coefficient vector c_{Set(k)},

$${h}_{Set ( k )} = {Uc}_{Set ( k )} = {\sum }_{i = 1}^{{r}_{env}} {c}_{Set ( k )} [ i ] U [ : , i ] ,$$

a linear tensorization can be

$${ℋ}_{Set ( k )} = {\sum }_{i = 1}^{{r}_{env}} {c}_{Set ( k )} [ i ] tensorize ( U [ : , i ] ) -> {H}_{Set ( k ) , RBG 1} = \frac{{\sum }_{RE = 1}^{RE = {N}_{RBG}} {\sum }_{i = 1}^{{r}_{env}} {c}_{Set ( k )} [ i ] tensorize ( U [ : , i ] ) [ RE , : , : ]}{{N}_{RBG}} = \frac{{\sum }_{i = 1}^{{r}_{env}} {c}_{Set ( k )} [ i ] {\sum }_{RE = 1}^{RE = {N}_{RBG}} tensorize ( U [ : , i ] ) [ RE , : , : ]}{{N}_{RBG}}$$

Denote

$${u}_{i , l} = {\sum }_{RE = ( l - 1 ) \cdot {N}_{RBG}}^{RE = l \cdot {N}_{RBG}} tensorize ( U [ : , i ] ) [ RE , : , : ]$$

as N_{Tx}-by-N_{Rx} matrix that is the i-th column of basis U tensorized and averaged on the l-th RBG. So, it is unnecessary to store H_{Set(k),RBG1}, because it can be computed by c_{Set(k)} and u_{i,1}, i=1, 2, . . . , rₑₙᵥ. As all the reference channels share the basis U, u_{i,1}, i=1, 2, . . . , rₑₙᵥ, l=1, 2, . . . , N_{RBG} is shared as well:

$${H}_{Set ( k ) , RBG - l} = \frac{{\sum }_{i = 1}^{{r}_{env}} {c}_{Set ( k )} [ i ] {u}_{i , l}}{{N}_{RBG}} .$$

Moreover, H_{Set(k),RBG-l} can be QRD into a N_{Tx}-by-N_{Rx} orthonormal projection matrix Q_{Set(k),RBG-l} and a N_{Rx}-by-N_{Rx} up-triangular square matrix R_{Set(k),RBG-l}: H_{Set(k),RBG-l}=Q_{Set(k),RBG-l}R_{Set(k),RBG-l}. By using projection matrix Q_{Set(k),RBG-l} to compress u_{i,l}:

$${R}_{Set ( k ) , RBG - l} = {{Q}_{Set ( k ) , RBG - l}}^{H} {H}_{Set ( k ) , RBG - l} = {{Q}_{Set ( k ) , RBG - l}}^{H} \frac{{\sum }_{i = 1}^{{r}_{env}} {c}_{Set ( k )} [ i ] {u}_{i , l}}{{N}_{RBG}} = \frac{{\sum }_{i = 1}^{{r}_{env}} {c}_{Set ( k )} [ i ] {r}_{i , l , Set ( k )}}{{N}_{RBG}}$$

where r_{i,l,Set(k)}=Q_{Set(k),RBG-l}^{H}u_{i,l} is a N_{Rx}-by-N_{Rx} square matrix.

The current invention can be used to solve the pilot design problem for T-MIMO system where there is large number for transmitter and receiver antenna ports and large bandwidth. The same method can be also applied to normal MIMO system (for example, 5G MIMO system), or even single antenna system.

By using the current invention, the following characters will show up in the system:

Require prior-knowledge of channel status of the target environment. This means the system acquires the channel space basis (U) or similar channel-status-related representation of the target environment. The pilot usage or overhead can be saved thanks to the prior-knowledge of channel status of the target environment.

The pilot pattern(s) are far sparser than traditional pilot pattern(s) (5G NR pilot design) and could be non-uniformly distributed along time-frequency-spatial resources.

A new method/procedure of Massive MIMO for wireless communication
BS transmits reference signal to UE
UE obtain the information of both the project matrix U and the anchor channel data and feedback them to BS
   The feedback information could be
      Alt.1: Matrix U and anchor channel H
      Alt.2: The projection of U to a predefined matrix, e.g. DFT matrix and anchor channel H
      Alt.3: Matrix U and a set of matrix Q, which is related to anchor channel H
      Alt.4: The projection of U to a predefined matrix, e.g. DFT matrix and a set of matrix Q, which is related to anchor channel H
      Alt.5: a set of Matrix Q and R, which is related to anchor channel H and the project matrix U
BS transmits a reference signal to track the anchor channel data
   The reference signal for tracking anchor channel could be
      Alt.1: the sparse reference signal, which could be derived from the feedback matrix U
      Alt.2: Non-precoded reference signal
      Alt.3: precoding reference signal
         The matrix Q as precoding is applied on reference signal
UE perform channel measurement on top of the reference signal and feedback if the anchored channel need be updated
   The metric of the similarity between the measured channel and the anchored channel is pre-defined and/or configured by network

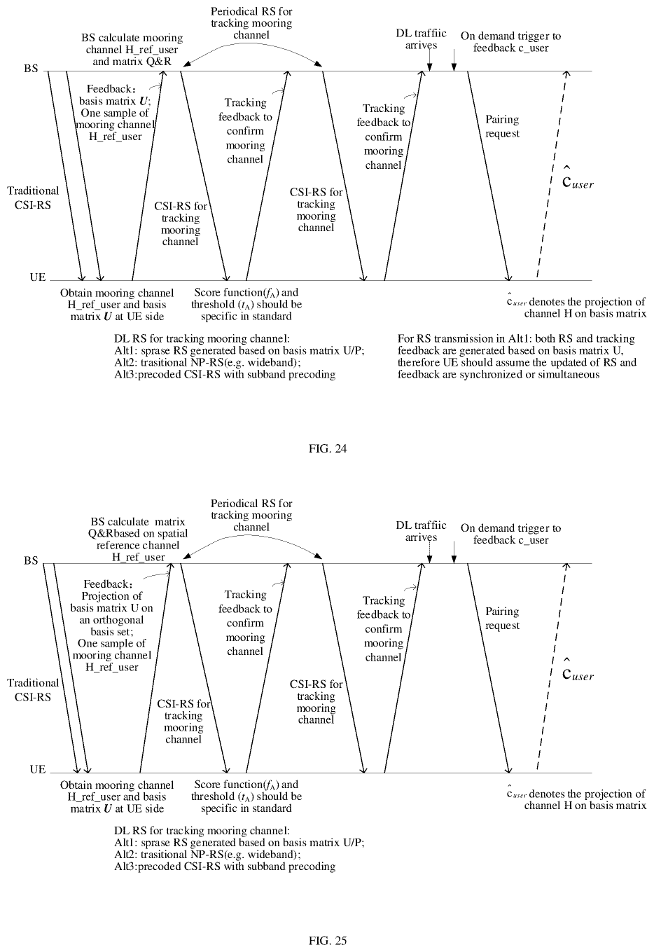

FIG. 24: Embodiment 1

FIG. 25: Embodiment 2

FIG. 26: Embodiment 3

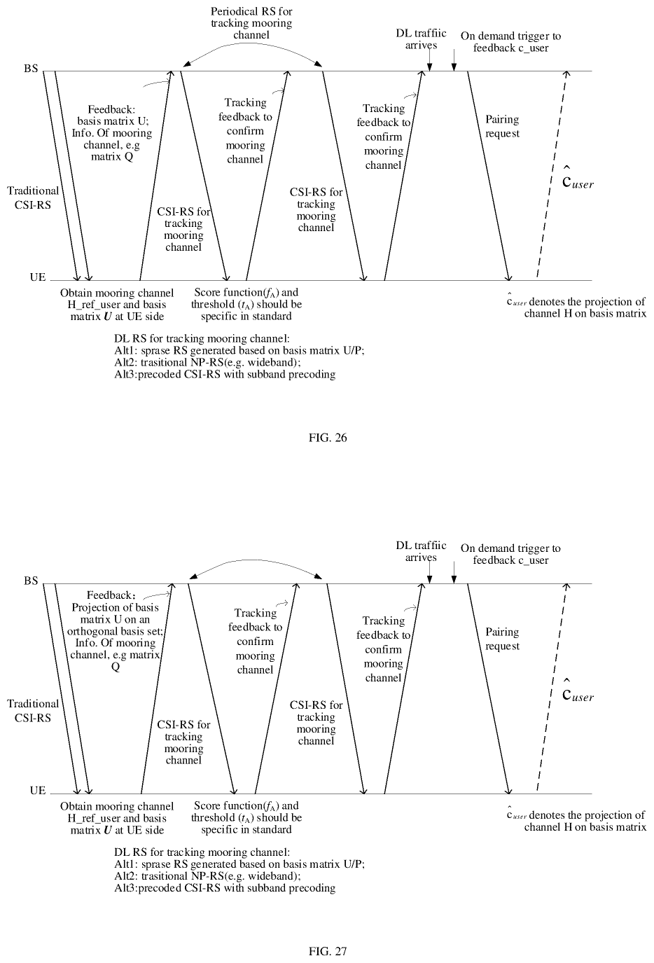

FIG. 27: Embodiment 4

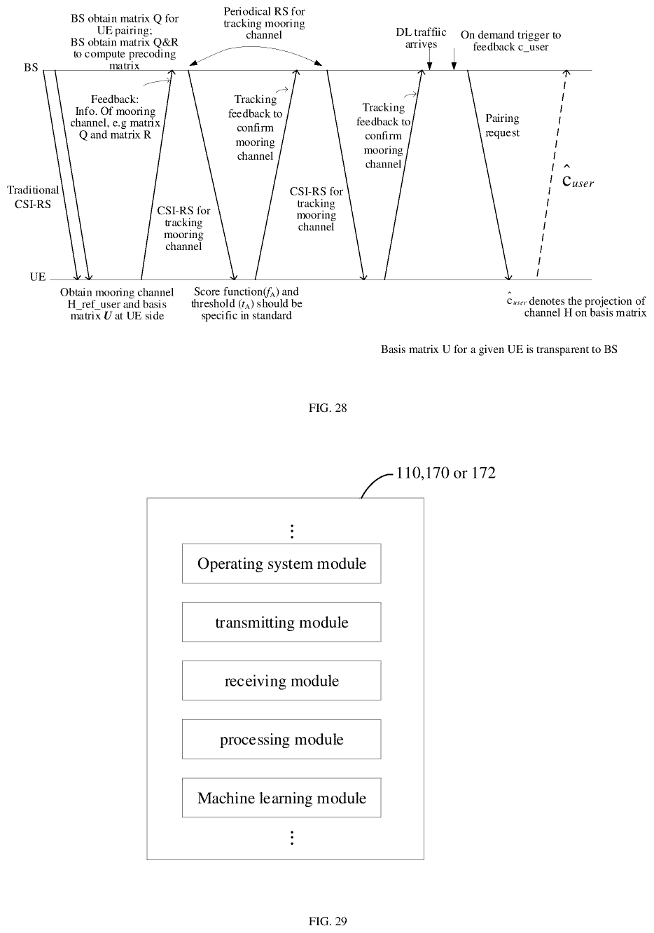

FIG. 28: Embodiment 5
[1] PCT/CN2022/126878 A Method And Apparatus of Channel Estimation for MIMO System
[2] PCT/CN2022/094688 An Method to Design Transmission Dimensionality and Reference Signal Placement Scheme for a Dimensional Transmission Channel by its Prior Structures
[3] Pivot-QRD: https://en.wikipedia.org/wiki/QR_decomposition
[4] SVD: https://en.wikipedia.org/wiki/QR_decomposition
[5] Pseudo-Inverse: https://en.wikipedia.org/wiki/Moore%E2%80%93Penrose_inverse
[6] MSE: https://en.wikipedia.org/wiki/Mean_squared_error
[7] Condition number of matrix: https://en.wikipedia.org/wiki/Condition_number

### 6G System Structure

### 2.3 6G Basic Module Structure

One or more steps of the embodiment methods provided herein may be performed by corresponding units or modules, according to FIG. 29. FIG. 29 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

What is claimed is:

1. A method, comprising:
obtaining common information and information of K reference channel(s), wherein the K reference channel(s) is related to an environment parameter set, the common information is used for determining information of a downlink (DL) channel, and K is a positive integer; and
transmitting feedback information based on the common information and the information of the K reference channel(s), wherein the feedback information comprises the information of the DL channel.

2. The method according to claim 1, wherein the information of the DL channel comprises index(es) of first reference channel(s), and a distance between the DL channel and a first reference channel is less than or equal to a threshold.

3. The method according to claim 1, further comprising:
transmitting the common information and the information of the K reference channel(s).

4. The method according to claim 1, further comprising:
determining whether the first reference channel(s) needs to be updated by channel measurement.

5. The method according to claim 1, wherein the common information comprises any one of:
a channel space basis U, or projection of a channel space basis U to a predefined matrix, wherein the common information is represented based on a matrix; or
a first parameter of an encoding deep-learning neural network (DNN) function and a second parameter of a decoding DNN function, wherein the common information is represented based on a DNN.

6. A method, comprising:
receiving feedback information, wherein the feedback information comprises information of a downlink (DL) channel, the feedback information is based on common information and information of K reference channel(s), the K reference channel(s) is related to an environment parameter set, the common information is used for determining the information of the DL channel, and K is a positive integer.

7. The method according to claim 6, wherein the information of the DL channel comprises index(es) of first reference channel(s), and a distance between the DL channel and a first reference channel is less than or equal to a threshold.

8. The method according to claim 6, further comprising:
receiving the common information and the information of the K reference channel(s).

9. The method according to claim 6, further comprising:
transmitting a reference signal for determining whether the first reference channel(s) needs to be updated.

10. The method according to claim 6, wherein the common information comprises any one of:
a channel space basis U, or projection of a channel space basis U to a predefined matrix, wherein the common information is represented based on a matrix; or
a first parameter of an encoding deep-learning neural network (DNN) function and a second parameter of a decoding DNN function, wherein the common information is represented based on a DNN.

11. An apparatus, comprising:
at least one processor coupled with at least one memory storing one or more instructions that are capable of being run on the at least one processor, wherein when the one or more instructions are run, the apparatus is enabled to:
obtain common information and information of K reference channel(s), wherein the K reference channel(s) is related to an environment parameter set, the common information is used for determining information of a downlink (DL) channel, and K is a positive integer; and
transmit feedback information based on the common information and the information of the K reference channel(s), wherein the feedback information comprises the information of the DL channel.

12. The apparatus according to claim 11, wherein the information of the DL channel comprises index(es) of first reference channel(s), and a distance between the DL channel and a first reference channel is less than or equal to a threshold.

13. The apparatus according to claim 11, wherein the apparatus is further enabled to:
transmit the common information and the information of the K reference channel(s).

14. The apparatus according to claim 11, wherein the apparatus is further enabled to:
determine whether the first reference channel(s) needs to be updated by channel measurement.

15. The apparatus according to claim 11, wherein the common information comprises any one of:
a channel space basis U, or projection of a channel space basis U to a predefined matrix, wherein the common information is represented based on a matrix; or
a first parameter of an encoding deep-learning neural network (DNN) function and a second parameter of a decoding DNN function, wherein the common information is represented based on a DNN.

16. An apparatus, comprising:
at least one processor coupled with at least one memory storing one or more instructions that are capable of being run on the at least one processor, wherein when the one or more instructions are run, the apparatus is enabled to:
receive feedback information, wherein the feedback information comprises information of a downlink (DL) channel, the feedback information is based on common information and information of K reference channel(s), the K reference channel(s) is related to an environment parameter set, the common information is used for determining the information of the DL channel, and K is a positive integer.

17. The apparatus according to claim 16, wherein the information of the DL channel comprises index(es) of first reference channel(s), and a distance between the DL channel and a first reference channel is less than or equal to a threshold.

18. The apparatus according to claim 16, wherein the apparatus is further enabled to:
receiving the common information and the information of the K reference channel(s).

19. The apparatus according to claim 16, wherein the apparatus is further enabled to:
transmitting a reference signal for determining whether the first reference channel(s) needs to be updated.

20. The apparatus according to claim 16, wherein the common information comprises any one of:
a channel space basis U, or projection of a channel space basis U to a predefined matrix, wherein the common information is represented based on a matrix; or
a first parameter of an encoding deep-learning neural network (DNN) function and a second parameter of a decoding DNN function, wherein the common information is represented based on a DNN.
